(19) United States
(12) Patent Application Publication
(10) Pub. No.: US 2004/0024662 A1
(43) Pub. Date: Feb. 5, 2004

(54) Equipment documentation management system, method, and software tools

(76) Inventors: David Gray, Sharon (CA); Glenn Morell, Toronto (CA); Dennis Wu, Toronto (CA); Craig Daniel, Oakville (CA); Brian Moore, Burlington (CA); Paul Brink, Toronto (CA)

Correspondence Address: BROWN, RAYSMAN, MILLSTEIN, FELDER & STEINER LLP, 900 THIRD AVENUE, NEW YORK, NY, 10022, US

(21) Appl. No.: 10/211,937

(22) Filed: Aug. 2, 2002

(51) Int. Cl. G06F 17/60

(52) U.S. Cl. 705/29

(57) ABSTRACT

Methods, software tools and systems are provided for facilitating management of equipment data and documentation in plants. Data on plant equipment is extracted from plant enterprise resource planning or similar systems and formed into a structured hierarchical tree. The tree relates to a database which acts as a template of the data and documents expected to be associated with the equipment Auditors use this data structure to audit the equipment collect documents and generate electronic versions of the documents. An assessor tool allows plants to select and parse the documents into elements such as diagrams, bills of materials, text, etc., and to select how these elements are to be processed. The assessed content is uploaded to a conversion network which manages a network of vendors who perform the processing in accordance with a workflow controlled by the conversion network. The processed structured content is reaggregated and indexed in the equipment tree. An equipment data and documentation database is returned to the plant, made available for viewing and manipulation using a software tool by those needing access to the information, and may be integrated with the plant's enterprise resource planning system and matched with inventory using SKU matching.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

Plants such as power plants, petroleum refineries, mining operations, and manufacturing facilities, use and maintain a large amount of electrical, mechanical, and control and instrumentation equipment. Maintaining this equipment in optimal operating condition is naturally of paramount importance to the productive and efficient operation of these plants. To this end plants employ equipment managers to maintain the equipment, diagnose problems, replace parts as necessary, and generally keep the equipment operating at a high level.

To do their jobs effectively, equipment managers need quick access to all necessary information about the equipment. The equipment vendors typically provide extensive manuals along with their equipment. These manuals are generally stored in one or more libraries on plant premises so that the equipment managers can locate them and obtain the necessary information. These libraries can sometimes be placed a fair distance from the equipment, costing the manager valuable time to retrieve and return the manuals. Also, as with most documentation, these manuals are subject to being lost, torn, or otherwise made unusable, may only be used from one location and by one person at a given time. Moreover, manuals become outdated over time, such as due to design specification changes, replacement of equipment, and the like.

It is desirable therefore for the plant to retain electronic versions of the equipment manuals, to keep the manuals updated, and to make these electronic manuals available from locations that may be remote. The potential solution, of simply scanning all the manuals into electronic files and making them available, is fraught with numerous logistical difficulties, technical challenges, potential inaccuracies, and high costs. It also fails to address the need to organize the documents and the data contained in them, both initially and on an ongoing basis.

Therefore, there's a need for innovative, efficient, and cost effective methods and systems to audit as-installed equipment and collect relevant manuals, and facilitate conversion of the numerous and voluminous equipment manuals present in a plant into an electronic form that is accurate, useable, and makes plant equipment managers significantly more productive in their work. The present application describes such systems and methods as well as related software tools.

### BRIEF SUMMARY OF THE INVENTION

Generally, the present invention provides a variety of methodologies and associated software tools for use by a plant and one or more additional entities to facilitate an efficient audit and collection of the plant's asset manuals, conversion of the manuals to make their content particularly useful, and integration with existing plant asset management systems. The methods and tools described herein may be used together to provide a complete end-to-end solution to the current problems as outlined above and additional problems recognized by the present inventors. In addition, many of the methods and tools described herein are useful on a stand-alone basis, or in combinations with one or more other methods and tools.

In accordance with one aspect of the present invention, an overall process begins with the download of asset related data from a plant's existing asset management system such as an enterprise resource planning system (“ERP”), enterprise asset management system (“EAM”), computerized maintenance management system (“CMMS”), or similar system. A software tool and associated data model is provided which serves as a template for a structured hierarchical tree of classes of assets, subassets or parts, and documentation expected to found in association with these asserts and parts. The software tool applies the data model to the data downloaded to produce a structured hierarchical tree of assets and related documentation expected to be located or relevant to the plant.

This structured tree is provided to auditors such as via a hand held computing device, who then perform a walk-through of the plant to verify assets and locate hard copies of the documents, which are then scanned into electronic form. In addition, auditors may try to obtain electronic copies of the documents where available from the plant or directly from the asset distributor. Once electronic versions of all or substantially all plant documents are aggregated, the documents are associated with the equipment in the structured tree, providing a comprehensive data structure which captures the plant's documents and their functional association with plant assets. In some embodiments, this verified data structure and the data contained in it are used to feed into other existing systems of the plant in place of ERP data or alternatively is used to configure existing systems including ERP systems to ensure that the data they contain is accurate and current.

This tree may then be used by the plant to select documents for processing into structured content. A software tool is provided for assessing the documents and identifying portions or elements of the documents for further processing. The elements may be categorized with different processing types, and the assessor selects parameters for use during the processing. The categorized document elements are stored with the processing parameters, and transmitted to a conversion network for processing in accordance with the user's selections using the content assessor software tool.

The conversion network receives various document elements and processing parameters from one or more plants, and coordinates the processing of these elements through a network of outside conversion vendors or other entities. The conversion network checks incoming processing requests and elements for consistency and proper form, manages the workflow among the various conversion entities, and helps monitor quality and cost of the processing services. The workflow management includes managing scheduling between various tasks that must be performed in a given sequence. The resulting processed document elements are returned to the plants as structured, processed content.

Plants are further provided with a software tool that allows viewing and navigation between documents and document elements. In addition, the use of the structured hierarchical tree generated during the audit phase of the overall process facilitates integration of the document elements with the plant's asset management system. Moreover, methods and tools are provided for the plant's use in matching parts of the structured content to operator specific data. For example, the system matches equipment parts as represented in the document elements with SKUs in the asset management system to allow inventory checking for parts, requisitioning parts as needed, and other system level functions. The asset management system may further be used to store digital photos of parts in inventory for visual comparison with parts shown in the processed document elements such as diagrams.

In accordance with further aspects of the present invention, described herein are methods and systems for managing a set of documentation relating to equipment used in a plant. One method involves selecting a list of documents at least in part through access to stored data in an equipment management system used by the plant, such as an enterprise resource planning or enterprise asset management system. In some embodiments, the list of documents is advantageously selected to represent documentation expected to be found within the plant and relevant to plant operation, e.g., not for use with machinery, which has been replaced. In addition, in some embodiments the document list is structured as a hierarchical tree of equipment, parts and documents.

Electronic versions of all or some of the selected documents in the list are then aggregated. This may be accomplished by performing a physical audit of the plant, especially the plant library, and collecting hard or soft copies of the documentation in the list. If more than one person is needed to perform the walk-through, the document list may be broken into two or more parts, and each person provided with a portion of the list in electronic form for use with a portable computing device. Alternatively, or in combination with this, if available, electronic copies of the documentation may be obtained directly from the source of the documentation, such as the equipment vendor or distributor.

The aggregated electronic documents are then converted into structured documents having a number of categorized document elements. The electronic documents may be converted by dividing each electronic document into two or more document elements and associating each document element with a processing category. In some embodiments, these processes are facilitated through use of a specially designed software tool. The software tool may further allow selection of one or more processing parameters for processing of the categorized document elements, and for storing the selected processing parameters with the categorized document elements such as in metadata. Processing of the categorized document elements are then coordinated in accordance with predetermined criteria. Coordinating processing may involve coordinating a network of entities such as outside vendors each capable of performing one or more specific processing tasks, managing the workflow of these vendors, and monitoring their performance.

In some embodiments, data from the processed document elements is integrated with the plant's existing enterprise systems such as an equipment management system and/or a warehouse management system operated by the plant. The integration with the plant's warehouse management system may involve matching equipment parts identified in the one or more processed document elements with parts identified by the plant's warehouse management system, such as by SKU number.

In some embodiments, an original equipment manufacturer (“OEM”) uses the system to better organize and disseminate information about the equipment they manufacture and sell to plants and other similar facilities which employ the system to structure content. The OEM publishes structured or unstructured information about their equipment to a generic content database maintained by a third party such as the Assignee of the present application or alternatively publishes the information to a content database maintained by the OEM. Plants and other facilities can thus retrieve the information published by the OEM and incorporate this information into their own structured content repositories.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a high-level flow diagram showing a method to generate structured content from a collection of documents in accordance with one embodiment of the present invention;

FIG. 2 is a block diagram depicting a high-level system architecture to process structured content in accordance with one embodiment of the present invention;

FIG. 3 is a high-level flow schematic diagram depicting a system and method which creates structured content from an equipment list in accordance with one embodiment of the present invention;

FIG. 4 is a high-level flow schematic diagram depicting a system used by multiple companies to create structured content in an industrial setting in accordance with one embodiment of the present invention;

FIG. 5 is a detailed block diagram of the systems contained in a content tools client in accordance with one embodiment of the present invention;

FIG. 6 is a flow diagram showing a method to generate a list content for processing as structured content in accordance with one embodiment of the present invention;

FIG. 7 shows a sample screenshot of a potential asset list obtained from an ERP system in accordance with one embodiment of the present invention;

FIG. 8 shows a sample screenshot of a potential asset list from the ERP system of a coal plant depicted as a tree hierarchy and a structured tree hierarchy data model of expected coal plant assets in accordance with one embodiment of the present invention;

FIG. 9 shows a sample screenshot of the display of a PDA, computerized tablet, or other computing device used to perform an audit matching items on an expected asset list with those items actually in use or present at a plant in accordance with one embodiment of the present invention;

FIG. 10 shows a sample screenshot of the display of a PDA, computerized tablet, or other computing device used to perform an audit matching items on an expected asset list with those items actually in use or present at a plant in accordance with one embodiment of the present invention;

FIG. 11 shows a sample screenshot of the display of a PDA, computerized tablet, or other computing device used to perform an audit matching items on an expected asset list with those items actually in use or present at a plant in accordance with one embodiment of the present invention;

FIG. 12 shows a sample screenshot of a structured data model representing information expected to be associated with assets contained in a verified list of assets in accordance with one embodiment of the present invention;

FIG. 13 shows a sample screenshot from an administration module of a content tools client depicting a high-level management control center in accordance with one embodiment of the present invention;

FIG. 14 shows a sample screenshot from an administration module of a content tools client depicting a site management control center in accordance with one embodiment of the present invention;

FIG. 15 shows a sample screenshot from an administration module of a content tools client shown depicting an equipment search tab in accordance with one embodiment of the present invention;

FIG. 16 is a flow diagram showing a method to pass workflow through a content assessor module in accordance with one embodiment of the present invention;

FIG. 17 is a detailed flow diagram showing a method to pass workflow through a content assessor module in accordance with one embodiment of the present invention;

FIG. 18 shows a sample screen display of a content assessor tool in accordance with one embodiment of the present invention;

FIG. 19 shows a sample screenshot from a content assessor module in accordance with one embodiment of the present invention;

FIG. 20 is a flow-schematic diagram showing an exemplary use of metadata in a content assessor module in accordance with one embodiment of the present invention;

FIG. 21 is a flow diagram showing a method of processing assessed content in a content conversion network in accordance with one embodiment of the present invention;

FIG. 22 is a block diagram depicting a system architecture of a content conversion network in accordance with one embodiment of the present invention;

FIG. 23 is a detailed flow diagram showing a method to process assessed content in a content conversion network in accordance with one embodiment of the present invention;

FIG. 24 is a flow-schematic diagram showing assessed content being processed in a content conversion network in accordance with one embodiment of the present invention;

FIG. 25 is a detailed block diagram of the systems contained in a content management server in accordance with one embodiment of the present invention;

FIG. 26 is a flow diagram showing a method to match company SKU numbers with structured content in accordance with one embodiment of the present invention;

FIG. 27 is a detailed flow diagram showing a method to match company SKU numbers with structured content in accordance with one embodiment of the present invention;

FIG. 28 shows a sample screenshot of a user interface of a SKU mapping tab for matching company SKUs with structured content in accordance with one embodiment of the present invention;

FIG. 29 shows a sample screenshot of a content viewer client to display structured content in accordance with one embodiment of the present invention; and

FIG. 30 shows a sample screenshot of a content viewer client to display structured content in accordance with one embodiment of the present invention.

### DESCRIPTION OF THE PREFERRED EMBODIMENTS

A suite of tools and methods is presented to transform documents used in the operation of facilities such as industrial plants and manufacturing sites. Documents are collected, reduced to their most discrete elements, and converted into structured content creating useful associations between elements. Information which was previously difficult to access is thus efficiently made readily accessible to users throughout the enterprise, which promotes the efficient operation of facilities.

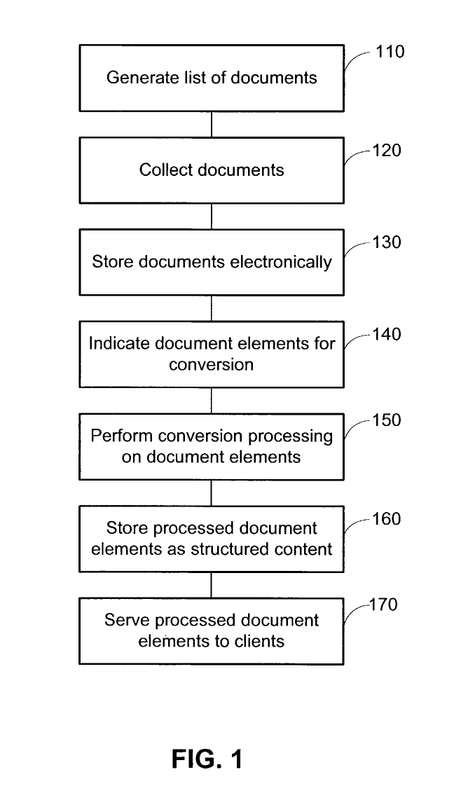

Embodiments of methods, systems, and software tools according to the present invention are described through references to FIGS. 1 through 30. Turning to FIG. 1, a high-level flow diagram depicts one embodiment of a method in accordance with the invention to generate structured content from a collection of documents. A list of documents is generated, step 110, that includes the set of all documents, which may be processed into structured content. The list of documents may be manually entered by a user, may be automatically generated according to systems and methods as described further below, or a combination thereof. The list of documents may include documents already stored in an accessible memory structure, documents which are not stored in an accessible memory structure, or combination thereof. Examples of documents already stored in an accessible memory structure are computer files such as text files, graphical files, multimedia files, and other types of files known in the art and capable of being stored in an accessible memory structure. A parts manual stored in a company's existing ERP system or other enterprise system is another example of a document already stored in an accessible memory structure. Examples of documents not stored in an accessible memory structure include computer files, as well as “hard copy” documents such as papers, books, manuals, microfilm, microfiche, and other types of media known in the art and capable of storing information.

The documents set forth on the list of documents are collected, step 120, and stored electronically, step 130, in order to process the documents into structured content. Those documents, such as paper manuals, which are not already stored in an accessible memory structure are collected by auditors working against the list of documents, scanned as graphical files, text files, or other appropriate file types known in the art, and stored electronically in a first accessible memory structure such as a database for further processing into structured content. Documents which are already stored in other accessible memory structures are also copied into this first accessible memory structure such that this first accessible memory structure contains electronic copies of all of the documents contained in the list of documents.

Documents will likely have various elements which need to be processed differently in order to be converted into structured content. In step 140, discrete document elements to be converted into structured content are indicated and parsed as separate files for future processing. Conversion processing is performed, step 150, on the document elements isolated in step 140. For example, graphical elements may need to be “hot pointed” and linked to other elements or require routine cleanup performed on artifacts such as those resulting from the scanning process. Textual elements might need to be captured using Optical Character Recognition (“OCR”) software or linked to other elements.

Processed elements are stored as structured content according to a predefined structured data model, step 160, and are served to clients requiring access to the information, step 170. In a manufacturing plant, for example, a plant operator might use a structured data model representing their particular plant. Processed elements extracted from scanned parts manuals could be stored in a tree hierarchy or other structured data model according to location within the plant, function, name, part number, or other distinguishing factor to provide a convenient reference and an easy method of quickly locating information pertaining to parts used in production. For example, a root node would represent the company, with branches on the next level representing plants owned by the company. The next level of the tree hierarchy has branches for systems or subsystems within the plant, and the leaves of the tree hierarchy represent individual machine assets or equipment.

Clients requesting access to the information include computer devices used by plant administrators connected to the plant's Local Area Network (“LAN”), personal digital assistants (“PDA”) used by workers on the plant floor, and other devices known in the art suitable for the display of structured content. Processing discrete elements of the individual manual pages and storing this information as structured content removes the limitations imposed by storing this information on a static page of paper, allowing users to view associations between related assets of a plant subsystem, obtain information about individual parts associated with specific assets, order parts needed for maintenance or repair, check local inventory, and perform many other tasks not currently available.

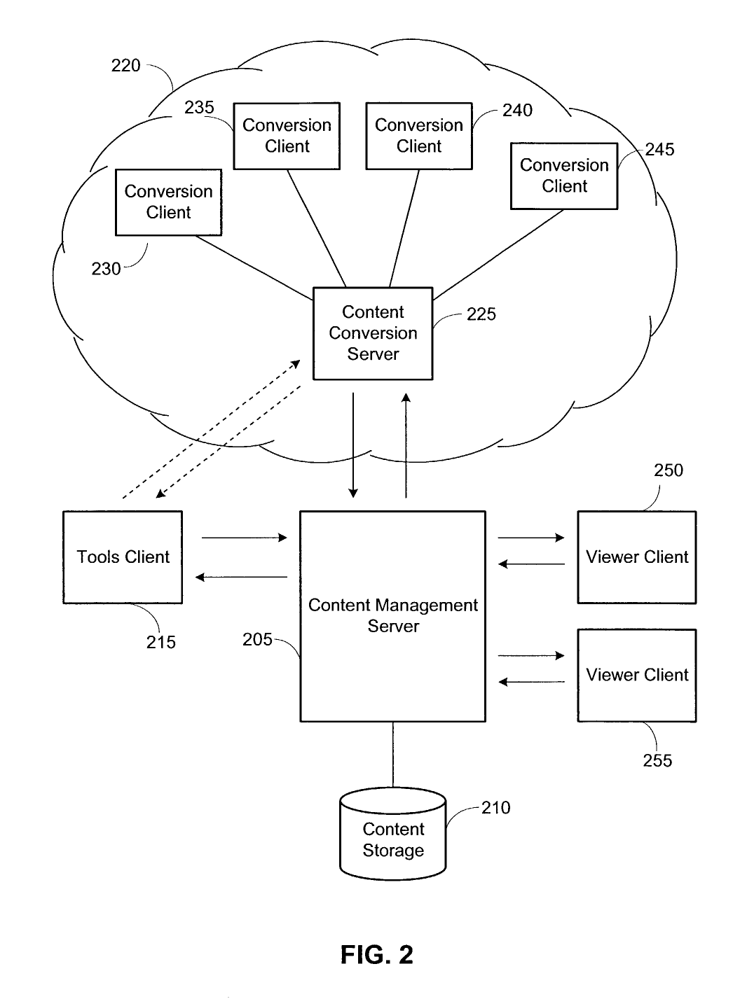

FIG. 2 is a block diagram depicting a high-level system architecture according to one embodiment of the present invention. The system includes a content management server 205, a content storage 210, a tools client 215, a content conversion network 220 including a content conversion server 225 and content conversion clients 230, 235, 240, and 245, and viewer clients 250 and 255.

The content management server 205 coordinates information exchange, controls content access, directs content conversion, and acts as a central hub for the system. The content management server 205 may include a single computing device or a plurality of computing devices to perform these functions.

Content is stored in the content storage 210 which may be a database or other accessible memory structure communicatively coupled to and controlled by the content management server 205. The content storage 210 includes documents collected during the content collection process, document elements awaiting conversion processing, and processed document elements organized as structured content. The content storage 210 may include additional information such as structured content data models, content templates, metadata associated with processed content, instructions regarding how the content should be presented, and other information useful in creating structured content according to the present invention.

The content tool client 215 is communicatively coupled to the content management server 205 and retrieves content for processing from the content database 210 via the content management server 205. The content tools client 215 performs much of the preprocessing work associated with preparing the content for conversion processing. The content tools client 215 associates tracking and identification information with content that is electronically stored. The content tools client 215 indicates the discrete document elements for conversion processing. The content tools client 215 also coordinates and administers procedures associated with generating a list of documents and manual collection efforts associated with the list of documents. Optionally, the content tools client also associates metadata with discrete document elements to assist in further processing these discrete document elements into structured content.

In the case of the manufacturing plant, for example and as further described below, the content tools client might associate Stock Keeping Unit (“SKU”) information obtained from the plant's existing ERP system with particular document elements or assets contained in the structured content tree hierarchy which would facilitate integration of the structured content system with existing fulfillment systems and other systems in the plant.

Also communicatively coupled to the content management server 205 is the content conversion network 220 where conversion processing is performed. The content network 220 includes one or more content conversion servers 225 which coordinate and schedule content conversion and are communicatively coupled to the content management server 205. The content conversion network 220 additionally includes one or more content conversion clients 230, 235, 240, and 245 which are communicatively coupled to content conversion server 225 and which perform the actual conversion processing.

Content conversion server 225 acts as a gateway to content conversion clients 230, 235, 240, and 245, scheduling and directing conversion processing of document elements, delivering content for processing, retrieving processed content, and generally coordinating and administering content conversion performed by content conversion clients 230, 235, 240, and 245.

As described further herein, identified document elements likely require different types of conversion processing. Graphical elements may need to be “hot pointed” and linked to other elements or require routine cleanup performed on artifacts resulting from the scanning process. Textual elements might need to be captured via OCR, linked to other elements, or incorporated into bills of materials (“BOM”) and tables of contents (“TOC”). In some embodiments, conversion clients 230, 235, 240, and 245 have different capability specializations in terms of conversion processing tasks and are assigned by content conversion server 225 to perform only those specialized tasks in conversion processing document elements. Dividing the workload and tasks performed during conversion processing in such a manner between different conversion clients results in increased quality, efficiency, and lowered costs of production.

For example, conversion client 230 might specialize in graphics cropping or some other type of image cleaning, conversion client 235 might specialize in BOM parsing, conversion client 240 might specialize in TOC creation, and conversion client 245 might specialize in creating hyperlinks between document elements or translation in a particular language. Configured in parallel as such, the conversion clients 230, 235, 240, and 245 are able to process more document elements in the same amount of time than they would be able to if they were configured to each serially and individually perform all of the specific conversion processing tasks outlined above.

Further, in some embodiments, each conversion client 230, 235, 240, 245 is an outside vendor, a subcontractor, or an employee paid to perform conversion processing. Some vendors, subcontractors, and employees will likely be better at performing certain tasks associated with the conversion process than others. Greater efficiency and maximum cost:benefit value is thus also achieved by assigning discrete tasks comprising only a part of the conversion process to the vendor, subcontractor, or employee best-suited to perform that particular task according to capability level of the individual vendor, subcontractor, or employee. Additionally, monitoring the speed and quality of the work performed by each conversion client permits continual adjustments to the outstanding vendor matrix by adding and subtracting vendors, adjusting the mix of work performed, and changing assigned specialties or work volume.

One or more content viewer clients 250 and 255 are also communicatively coupled to content management server 205. Content viewer clients 250 and 255 are computing devices and may include personal computer workstations, PDAs, computerized tablets, or other devices known in the art and suitable for displaying structured content. Content viewer clients 250 and 255 request structured content comprising converted document elements from content management server 205. The structured content is retrieved by content management server 205 from content storage 210 and delivered to content viewer clients 250 and 255 for further use. In some embodiments as further described herein, content viewer clients 250 and 255 function differently according to the identity of their user and provide different users with customized views uniquely suited to that particular user. For example, in a manufacturing plant, content viewer client 250 might be a wireless PDA or computerized tablet used by an engineer on the floor of the plant for troubleshooting plant systems and content viewer client 255 might be a personal computer workstation physically connected to the plant network and used by an office administrator in the main office for requisitioning inventory. Content viewer client 250 might only have access to structured data suitable for troubleshooting plant systems such as parts manuals, schematics, bills of materials, and other suitable structured data. Content viewer client 255 might have access to the aforementioned structured data, and also access to various information in other systems such as SKU numbers, and access to other systems such as the plant's existing ERP system for requisitioning inventory. Structured data may be displayed as a tree hierarchy or as lists, graphics, and other representations for displaying data known in the art. In some embodiments, different views of the structured data or a portion of the structured data may be presented to different users.

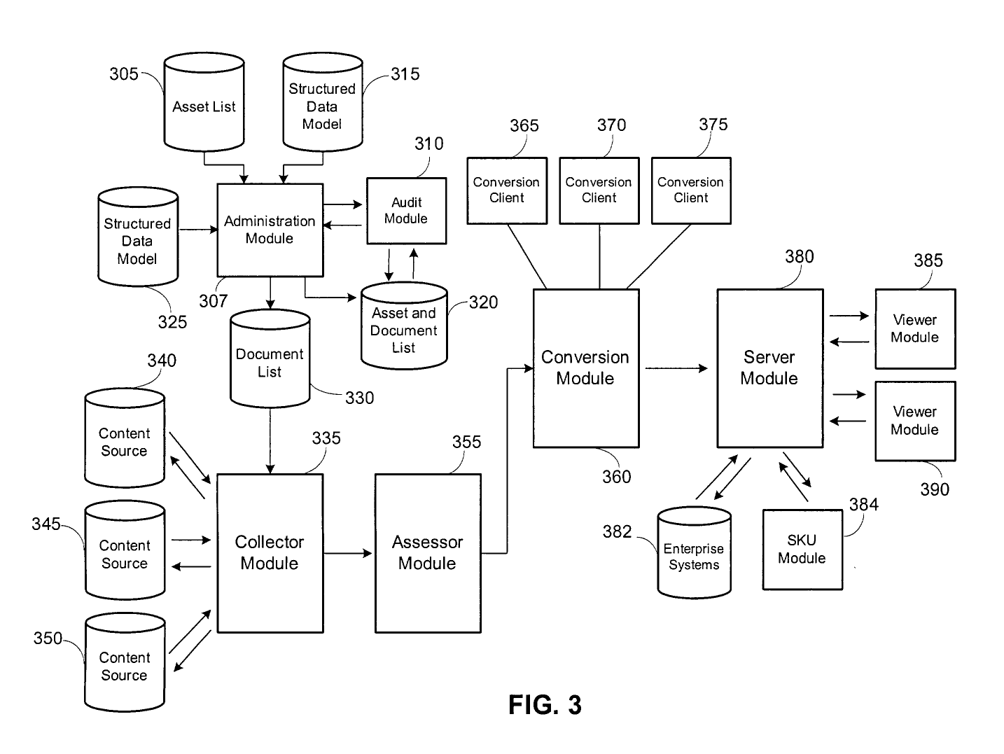

Turning to FIG. 3, a high-level flow schematic diagram is presented depicting one embodiment of a system and method in accordance with the present invention which creates structured content from an equipment list. This embodiment might, for example, be used in an industrial setting such as a power generating station, a petroleum refinery, a coal processing plant, a manufacturing factory, or some other setting where it would be useful to convert documentation related to production assets into structured content.

A first asset list 305 is generated comprising a functional hierarchy of the systems and subsystems in a plant and the equipment that comprises each subsystem. Asset list 305 is generated by extracting a list of equipment contained in an existing ERP system or other software application which uses an equipment list as an index, receiving manual input from a user, or receiving input from some other computer-readable means suitable for use in generating a list of items. As used herein, assets generally include equipment, parts, devices, chattels, fixtures, and other physical or software components used by a facility such as a plant or a factory and for which documentation, in hard or electronic form, is provided or generated.

As recognized herein, asset list 305, however, is not always an accurate representation of parts and other machine assets actually in use at a particular facility. Assets may be missing, assets may be duplicated, or assets may be contained on asset list 305 that are not actually used at the facility. Additionally, a company may have multiple sites or plants with different parts and machine assets at each location. Generating lists of assets such as asset list 305 does little to facilitate the operation of a facility unless the list is verified as accurate and the related documentation is somehow standardized as structured content capable of being manipulated in a useful manner.

A content administration module 307 coordinates data transfer between asset list 305, structured data model 315, and an audit module 310. Content administration module 307 modifies or associates information with content assets, facilitates content auditing and tracking, directs tasks performed by audit module 310, and monitors completion of those tasks. Content administration module 307 also serves as a user interface to accept input regarding assets, audit results, and other information used by the system. Content administration module 307 compares assets contained in asset list 305 with those assets identified in structured data model 315 to identify differences between them. The delta between asset list 305 and structured data model 315 represents assets which must be reconciled with asset list 305 to create a list of assets expected to be present at the plant. These expected assets and documents associated with these assets as set forth in structured data model 325 are incorporated into a second asset and document list 320 representing those assets expected to be present at the plant and their related documentation.

Structured data model 315 implemented in some embodiments as a standardized template comprising all machine assets expected to be found in a facility such as the one where the present invention is being practiced. Structured data model 315 is encoded using XML or some other language known in the art and suitable to create data structures of structured content. For example, if the present system was being used in a coal processing plant, then structured data model 315 could be encoded as an XML template representing a standard list of those machine assets expected to be found in a coal processing plant such as conveyor belts, pumps, scrubbers, and other similar assets.

Structured data model 325 is implemented in some embodiments as a standard template of all documents associated with a particular asset in a production facility such as the one in which the system is being used. For example, if asset list 320 contained a particular type of scrubber, then structured data model 325 contains a list of all documents recommended to be associated with use of that particular scrubber such as maintenance manuals, parts diagrams, drawings, and other documentation. Structured data model 325 is encoded using XML or some other language known in the art and suitable to create data structures of structured content.

Audit module 310 performs a sanity check on asset list 320 to verify that the items comprising asset list 320 are actually in use and/or present at the particular facility where the present invention is being practiced. Audit module 310 accepts and tracks input from auditors that perform a physical walkthrough of the plant to visually verify that the assets contained in asset list 320 are actually in use at the plant. The assets contained in asset list 320 are modified as necessary to accurately reflect the results of the audit and create a verified list of assets. Audit module 310 also accepts input from auditors into structured fields of asset list 320 indicating additional information associated with assets contained in asset list 320 such as nameplate information (including manufacturer, model, and serial number), technical specifications of the assets, other identifying information, and even visual images of the assets.

Content administration module 307 incorporates the results of the audit and compares structured data model 325 with the verified assets of asset list 320 to generate a structured document list 330 comprising a verified list of all documents associated with the operation and upkeep of all assets within the plant.

A collector module 335 uses structured document list 330 to track and direct the aggregation of all documents contained in structured document list 330. Collector module 335 retrieves these documents from one or more content sources 340, 345, and 350. Content sources 340, 345, and 350 may be obtained from different content repositories. According to one embodiment of the invention, content source 340 includes electronic document data stored as computer-readable files in an existing database at the plant such as document management systems (“DMS”), ERP systems, Enterprise Asset Management (“EAM”) systems, and Computerized Maintenance Management systems (“CMMS”), content source 345 includes maintenance manuals, engineering drawings, and other hard copy materials contained in a manual room at the plant, and content source 350 includes content not located at the plant and obtained from a third party such as the asset manufacturer or other source.

Collector module 335 also controls document scanners or other similar devices used to convert all documents retrieved from content sources 340, 345, and 350 that are not in a computer-readable format into an appropriate computer-readable format suitable for conversion processing into structured content. Examples of such a computer-readable format include text files, Tagged Image File Format (“TIFF”) files, and Portable Network Graphics (“PNG”) files.

As further described herein, documents collected by collector module 335 will likely have various elements which need to be processed differently in order to be converted into structured content. For example, graphical elements are generally treated differently than textual elements in the conversion process. Assessor module 355 evaluates collected documents, indicates discrete document elements to be converted into structured content, and parses these document elements as separate files for future processing. Assessor module 355 also optionally associates metadata (such as conversion instructions) with discrete document elements to assist in further processing these discrete document elements into structured content.

Conversion module 360 creates more detailed conversion instructions and tracks and directs the conversion of document element files parsed by assessor module 355. For example, graphical elements may need to be “hot pointed” and linked to other elements or require routine cleanup performed on artifacts resulting from the scanning process. Textual elements might need to be captured via OCR, linked to other elements, or incorporated into BOMs and TOCs.

Conversion clients 365, 370, and 375 perform the actual conversion processing of the document element files. In some embodiments, conversion clients 365, 370, and 375 have different capability specializations in terms of conversion processing tasks and are directed by conversion module 360 to perform only those specialized tasks in conversion processing document elements. As further described herein, dividing the workload and tasks performed during conversion processing in such a manner between different conversion clients results in increased efficiency, quality, and lowered costs of production. Conversion module 360 also monitors the work of conversion clients 365, 370, and 375, such as the efficiency and quality of the work. Monitoring the work performed by conversion clients 365, 370, and 375 permits continual adjustments to the outstanding vendor matrix by adding and subtracting vendors, adjusting the mix of work performed, and changing assigned specialties or work volume.

Server module 380 stores converted document elements. In some embodiments, server module 380 stores converted document elements as structured content according to structured data models 315 and/or 325 which may represent a tree hierarchy or other structured data model. Server module 380 is connected to existing enterprise systems 382 which, for example, may be integrated with the system to check current inventory levels or to prepare work orders. Server module 380 is also connected to a SKU module 384 which provides logic to match structured content customer SKUs with OEM part numbers from parts lists and other documents that were collected and converted into structured content. Server module 380 responds to requests made by one or more viewer modules 385 and 390 that server module 380 transmit content comprising converted document elements.

In some embodiments, viewer modules 385 and 390 function differently according to the identity of their user. For example, in a manufacturing plant, viewer module 385 might be a wireless PDA or computerized tablet used by an engineer on the floor of the plant for troubleshooting plant systems and viewer module 390 might be a personal computer workstation physically connected to the plant network and used by procurement personnel in the main office for requisitioning parts or equipment. Viewer module 385 might only have access to structured data suitable for troubleshooting plant systems such as parts manuals, schematics, bills of materials, and other suitable structured data. Viewer module 390 might have access to the aforementioned structured data, and also access to SKU numbers as well as the plant's existing ERP system for requisitioning inventory.

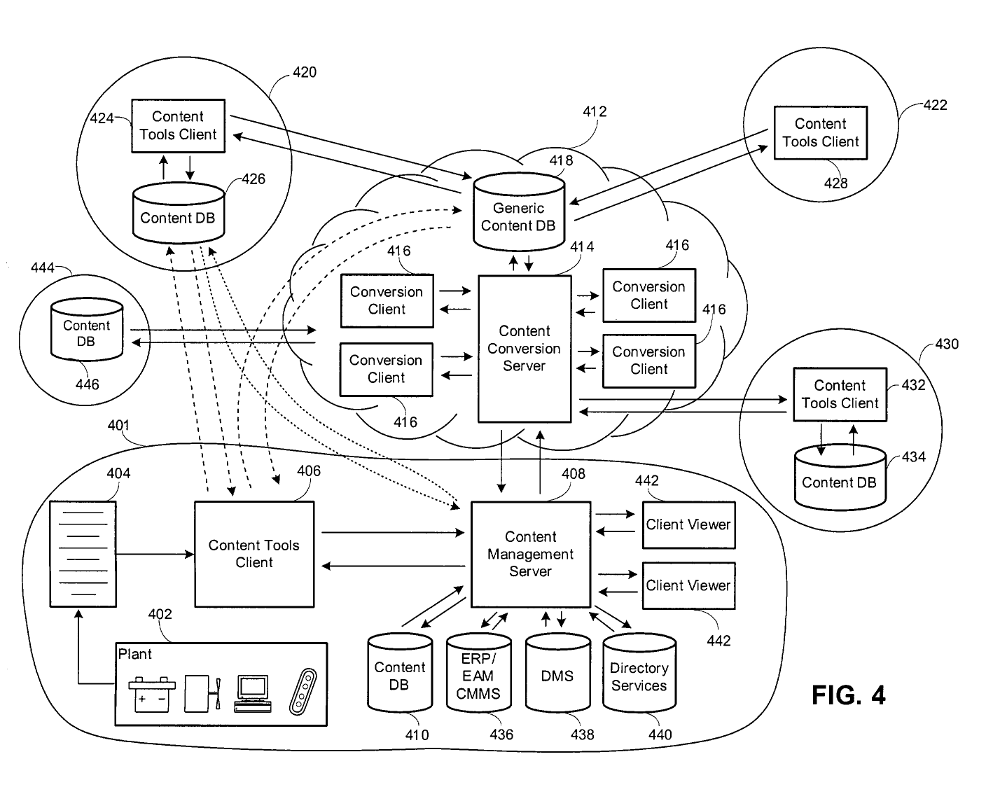

A more detailed embodiment is presented in FIG. 4 which depicts a system used by multiple companies in an industrial setting.

After an initial audit is performed by a first company 401 to standardize their plant 402 assets against a structured content template of plant 402 assets as previously described above, a collection of information content 404 is assembled for conversion into structured content. A content tools client 406 creates computer-readable files from information content 404 via scanning means, accepting manual input from users, or other suitable means. Content tools client 406 sends the computer-readable files created from information content 404 to content management server 408 for storage in a company content database 410. In some embodiments, a third party such as the Assignee of this patent application that specializes in creating tools for structured content creation may provide the content tools client 406 and the content management server 408 to first company 401.

Content tools client 406 assesses computer-readable files stored in company content database 410 which will likely have various elements that need to be processed differently in order to be converted into structured content. Content tools client 406 evaluates collected computer-readable files stored in company content database 410, indicates discrete document elements to be converted into structured content, and parses these document elements as separate files for future processing. Content tools client 406 also optionally associates metadata with discrete document elements to assist in further processing these discrete document elements into structured content.

A content conversion network 412 is also communicatively coupled to content management server 408. In some embodiments, a third party such as the Assignee of this patent application that specializes in creating tools for structured content creation may operate the content conversion network 412 to provide content conversion services. Content conversion network 412 processes document elements assessed by content tools client 406 into structured content. A content conversion server 414 communicates with content server 408 to retrieve document elements requiring conversion stored in company content database 410. Alternatively, content tools client 406 may communicate directly with content conversion server 414 regarding document elements requiring conversion and send document elements requiring conversion directly to content conversion server 414. Content conversion server 414 tracks and directs the content conversion process distributing document elements to one or more content conversion clients 416 that perform the actual conversion processing.

A generic content database 418 is communicatively coupled to content conversion server 414. Generic content database 418 stores content elements related to information content 404 which can be used to create structured data to associate with the structured data template of plant 402 assets generated above. For example, generic content database 418 may contain structured content or document elements submitted by third party companies 420 and 422 to content conversion network 412. Information content 404 collected as a result of plant 402 audit might not contain all information associated with assets of plant 402 and may need to be supplemented with document elements contained in generic content database 418. Perhaps a pump asset was identified in the initial audit, but a parts manual or other document associated with the pump asset was not located at plant 402. OEM company 422 might manufacture this pump and have already deposited document elements associated with the pump in generic content database 418. In some embodiments, content tools client 406 is communicatively coupled directly to generic content database 418.

In some embodiments, company 420 might chose to convert information associated with their products into structured data according to the present invention, but prefer to host the structured data generated pertaining to their products themselves rather than deposit this structured product data or product document elements in generic content database 418. Accordingly, company 420 operates their own content tools client 424 to assess their product information content and perform other tasks associated with content tool servers as described above. Company 420, in such an embodiment, would also have their own company content database 426 which may contain all or a portion of the structured product information content and product document elements company 420 generates. Company 420 may alternatively deposit a portion of its structured product content and product document elements in company content database 426 and a portion in generic content database 418. Optionally, company 420 may also permit content tool clients 406 associated with other companies to retrieve structured product content, product document elements, or raw unprocessed content from company content database 426.

In some embodiments, company 422 may chose to process its own product information to create structured product content and product document elements, but unlike company 420, company 422 does not wish to actually host this structured content itself. In such case, company 422 operates content tools client 428 to assess their product information content and perform other tasks associated with content tool servers as described above, but deposits the generated structured product content and product document elements in generic content database 418.

In some embodiments, another company 430 desires to process information to create structured product content and product document elements. Company 430, however, is not associated with other companies and wishes to use the generated structured content internally as opposed to sharing this structured content with other companies. Company 430 operates content tools client 432 to assess their product information content and perform other tasks associated with content tool servers as described further herein. Content tools client 432 submits assessed content to content conversion server 414 for content processing by conversion clients 416 and conversion server 414 returns processed content to content tools client 432 for storage in company content database 434. Company content database 434 is not accessible to other companies and only used internally by company 430.

In some embodiments, another company 444 desires to submit content for conversion contained in a company content database 446 directly to the content conversion network 412. Company 444 does not have a content tools client and instead uses traditional methods known in the art to submit content such as via FTP or other protocols suitable for information transfer. In some embodiments, company 444 may use a web browser or other method used to obtain software from an application service provider to access tools suitable for manipulating, assessing, modifying, and generally submitting content contained in content DB 446 to content conversion network 412 for processing. In some embodiments, company 444 submits raw content directly and leaves content assessment and content conversion to content conversion network 412.

Document elements derived from information content 404, generic content database 418, and company content database 426 are processed by content conversion network 412 and returned to content server 408 for storage in company content database 410. Also communicatively coupled to content server 408 are existing enterprise management systems 436 associated with company 401 such as ERP systems, EAM systems, and CMMS systems. These systems provide additional capabilities with respect to producing and using structured content generated. For example, integration with the existing ERP system permits checking inventory availability, work order integration, and associating SKU information with assets contained in the structured content. As described herein in the case of the manufacturing plant, for example, content server 406 might associate SKU information obtained from the plant's existing ERP system with particular document elements or assets contained in the structured content tree hierarchy which would facilitate integration of the structured content system with existing fulfillment systems and other systems in the plant.

Existing document management systems 438 are also communicatively coupled to content management server 408. DMS 438 contains computer-readable document files pertaining to plant 402 assets and other matters associated with company 401. Information contained in DMS 438 and associated with plant 402 assets is retrieved as described above to generate structured information content associated with plant 402 assets. Alternatively, structured content, unprocessed content, existing content, and combinations thereof may also be stored in DMS 438.

A directory services system 440 is also communicatively coupled to content management server 408 providing user management and authentication services to track and control access to the structured content stored in company content database 410. Content viewer clients 442 request content management server 408 deliver structured content stored in company content database 410. Content management server 408 utilizes directory services system 440 to authenticate user requests and permission levels. Optionally, as previously described, certain content viewer clients 442 have access to different kinds of structured content or different views or presentations of that content and other systems associated with the present invention based on job role, location, or other distinguishing factors as indicated by directory services system 440.

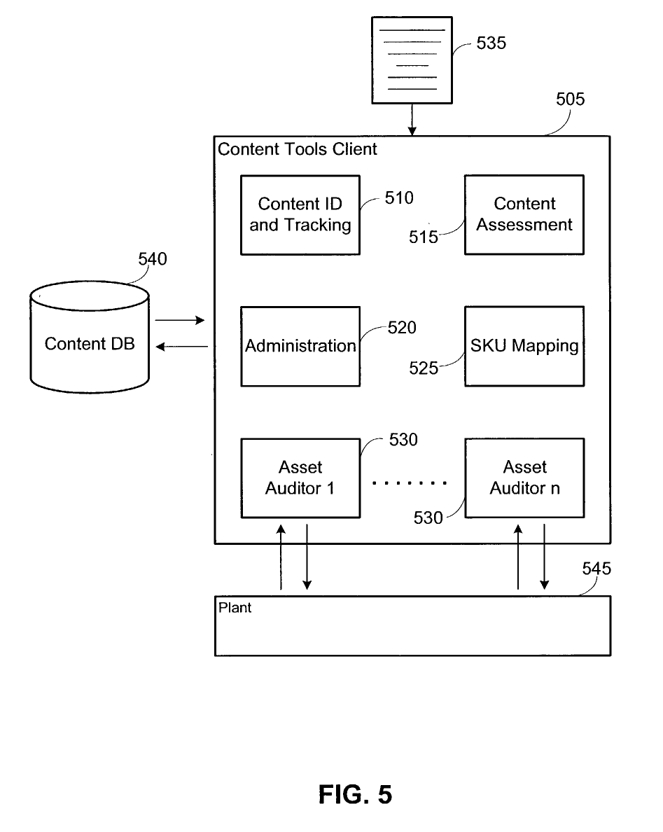

FIG. 5 presents a detailed block diagram of the systems contained in a content tools client according to one embodiment of the invention. A content tools client includes one or more programs or modules which perform tasks associated with creating structured content according to embodiments of the present invention. Content tools client 505 includes computer applications or modules including a content identification and tracking module 510, a content assessment module 515, a content administration module 520, a SKU mapping module 525, and one or more instantiations of asset auditor modules 530.

Information content 535 to be converted into structured content is assembled, converted into a computer-readable medium as necessary, and passed to content tools client 505 for further processing. Exemplary information content 535 may include paper documents, microfiche, microfilm, computer-readable files, and other information content suitable for conversion into structured content, as well as existing structured content accessible to a content server. In some embodiments, information content 535 may be related to or include machine assets in a manufacturing setting.

Content identification and tracking module 510 assigns each item of information content 535 a unique identifier. Unique identifiers are used to distinguish content items and facilitate the storage, retrieval, and processing of information content 535 items into structured content.

Information content 535 items receiving unique identifiers are stored in content database 540 which is a relational database such as Oracle9i by Oracle Corporation, SQL Server by Microsoft Corporation, or other data structure stored in memory communicatively coupled to content tools server 505, and suitable for the storage of information content 535 items. Information content 535 items are also retrieved from content database 540 for further processing into structured content. In some embodiments, content database 540 is directly communicatively coupled to content tools client 505. In other embodiments, content tools client 505 communicates requests to content database 540 via a content server or other intermediate network device. Content assessment module 515 retrieves from content database 540 information content 535 items to be processed into structured content. Content assessment module 515 indicates those discrete document elements contained in information content 535 items retrieved from content database 540 which require different kinds of processing when converted into structured content. Content assessment module 515 parses these elements as separate files, queries content identification and tracking module 510 to obtain a unique identifier and associations with related files for each newly created file, and stores these discrete content element files in content database 540 for future processing. In some embodiments, each separate file has metadata associated with it containing additional information regarding associations and processing instructions, as described below.

Content administration module 520 manages information content 535 items and discrete content elements stored in content database 540. Content administration module 520 modifies or associates information with content assets, facilitates content auditing and tracking, directs other tasks performed by content tools client 505, and monitors completion of those tasks. For example, a standard structured data model might indicate that information content 535 stored in content database 540 pertaining to a particular machine asset in a plant does not include the manufacturer name of the asset or some other item of important information. Content administration module 520 provides functions and subroutines that associate or accept input to associate such important information with information content 535 items. Content administration module 520 modifies corresponding records stored in content database 540 for the information content 535 to associate such important information. Content administration module 520 also indicates whether information content 535 items comprising machine assets or information associated with machine assets have been successfully located during audit procedures further described herein.

SKU mapping tool 525 associates or accepts input to associate SKU data with individual document elements derived from information content 535 items stored in content database 540. For example, a part number from a parts list might be matched to its corresponding local SKU. In some embodiments, SKU mapping tool 525 is integrated with existing ERP systems to facilitate association of SKU data. As further described herein, SKU mapping tool 525 also accepts data from logic routines that suggest likely associations of SKU data with individual document elements when an exact association between a particular document element and a particular SKU is not currently known.

One or more instantiations of asset auditor modules 530 integrate information obtained from audit activities performed at plant 545 or some other location with appropriate content information 535 items and individual document elements stored in content database 540. As further described herein, auditors using PDAs, computerized tablets, or other computer devices either communicatively coupled to or independent from content tools server 505, perform a coordinated physical walkthrough of plant 545 to visually verify that the assets comprising an initial proposed asset list are actually in use at the plant and to identify any additional assets which should be included on the list. Asset auditor module 530 also accepts input from auditors indicating additional information associated with assets such as nameplate information, other identifying information, and even visual images of the assets. Asset auditor module 530 also accepts input from auditors indicating whether documents and other information content 535 items associated with plant 545 assets as identified on a structured document list have been located and scheduled for processing by content tools client 505 and accepts input of additional document or information requirements arising through the audit process.

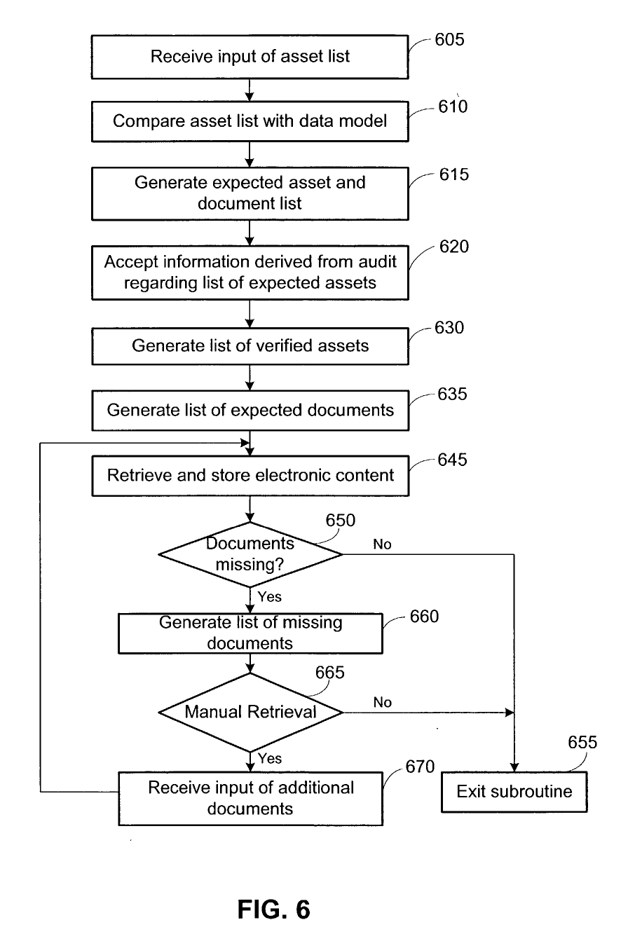

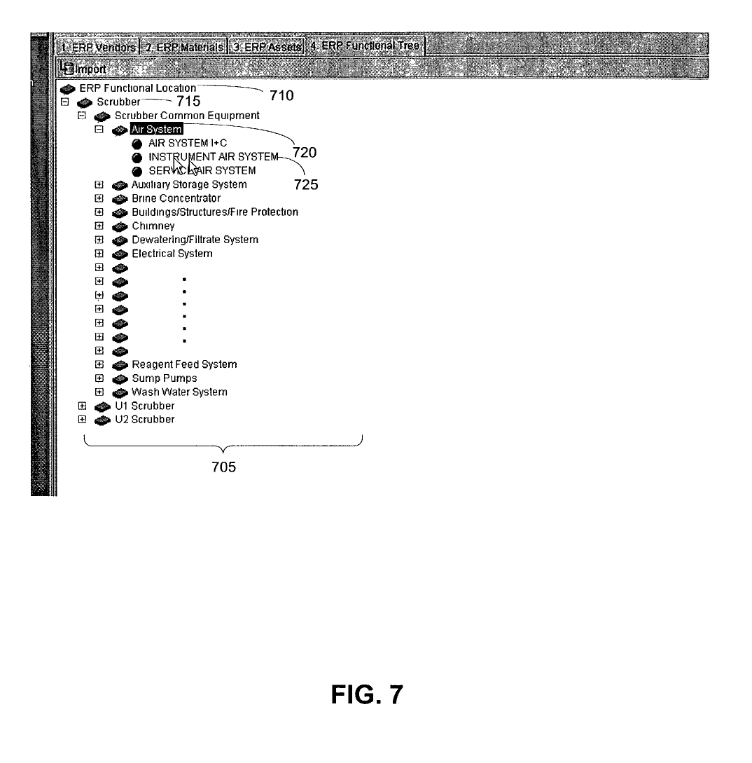

The audit and collection processes are further described generally with references to the flow diagrams in FIG. 6, and the screen displays of FIGS. 7-15. A list is received as input representing a list of potential assets for which structured content may be generated, step 605. For example, in an industrial context, the potential assets could be a list of machine parts and equipment retrieved from a company's existing ERP system via export methods known in the art such as comma-delimited text files or other file structures suitable for parsing and importing data into the system.

Referring to FIG. 7, a sample screenshot of a potential asset list 705 obtained from an ERP system is depicted as a tree hierarchy. A root node 710 is based upon the functional location of the assets. As used herein, the function location of an asset generally indicates how an asset is logically connected by function to other assets in a facility. For example, if a pump in a first building drives the cooling system for a turbine in a second building, the pump and the cooling system would be associated according to functional location. By contrast, the physical location of an asset, as used herein, generally indicates where an asset is used in a facility. In the preceding example, therefore, the pump and the cooling system would not be associated according to physical location. Branches at the next level represent individual systems 715 within the functional location such as scrubber systems. Other levels of branches represent various subsystems 720 of the parent system 715. In the example shown, the scrubber common equipment subsystem contains, inter alia, an air system subsystem. Finally, individual leaves or nodes 725 represent individual machine assets of the subsystems 720. The asset list, however, may not be an accurate representation of the assets actually in use at a particular facility. ERP systems, for example, are known to often contain legacy data pertaining to historical parts and equipment not currently used in the enterprise. Additionally, a company may have multiple sites or plants with different parts and machine assets at each location. Generating a list of assets alone as in step 605 does little to facilitate the operation of a facility unless the list is verified as accurate and the related documentation is somehow standardized as structured content capable of being manipulated in a useful manner.

Accordingly, the potential asset list is compared to a structured data model or standard template for the particular type of facility from which the asset list was obtained, step 610. This structured data model or standard template is a hierarchical data structure encoded in XML or some other suitable language populated with the list of all or substantially all assets and related documentation or information expected to be found in a particular facility of the type from which the list of potential assets was generated. In some embodiments, the assets of the structured data model or standard template include only those primary assets found at a majority of facilities of similar type and omit assets which are exceptionally rare or uncommon. The hierarchy of the data structure may be based upon the functional or physical location of the assets and information or based upon additional associations between elements including related documentation, safety procedures, and maintenance activities, and shutdown procedures.

The list of potential assets may omit certain assets contained in the structured data model which will be identified when the two lists are compared. Similarly, the comparison may identify assets contained in the list of potential assets which are not found in the structured data model. The list for audit purposes includes both types of exceptions in order to verify the audit results in an accurate description of the assets actually in the plant. Further, by mapping potential assets against the expected assets of a structured data model, the previously unstructured content of the potential asset list is transformed and standardized across the enterprise as structured data that may now be manipulated in a useful manner.

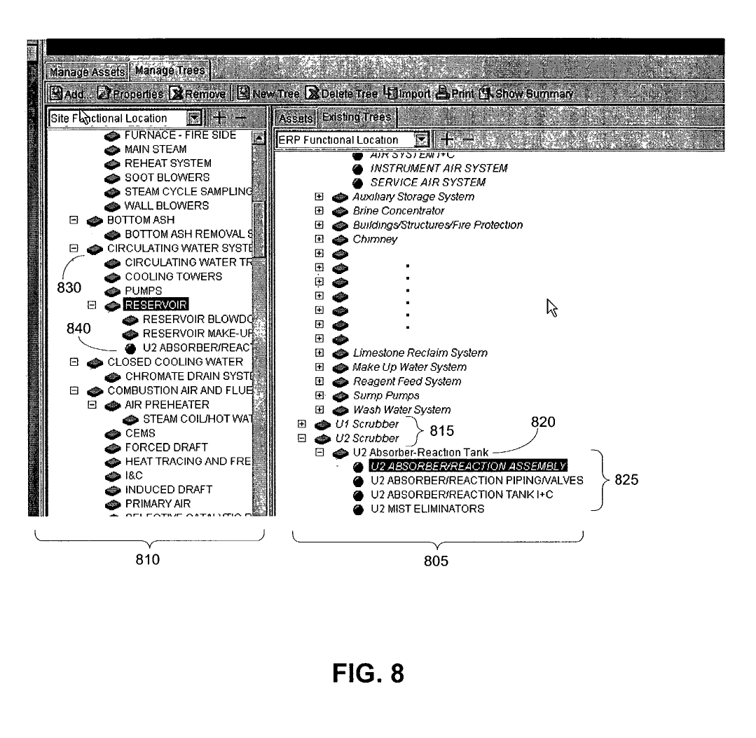

Referring to FIG. 8, a sample screenshot shows a potential asset list 805 from the ERP system of a coal plant depicted as a tree hierarchy and a structured tree hierarchy data model 810 of expected coal plant assets. Here, the systems 815, subsystems 820, and individual asset nodes 825 of potential asset list 805 are mapped against the systems 830, subsystems 835, and individual asset nodes 840 of data model 810 to create and populate a standardized structured list of expected assets. Mapping and population of the standardized structured list of expected assets may be done manually as directed by a user, automatically according to preferences determined by the system, or combinations thereof.

Referring again to FIG. 6, a standardized structured list of expected assets and related documents or information is thus created, step 615. This list is still a theoretical list of assets that are merely expected in the enterprise since no independent verification has been performed that the assets actually exist. To verify that the expected asset list is accurate, a physical audit of the facility is performed matching items on the expected asset list with assets actually in use or present at the facility and the information generated from this audit is incorporated into the structured list of expected assets, step 620. Warehouse digitization, tagging of equipment, and verification of piping and instrumentation diagrams (“P&IDs”), as well as component and wiring diagrams (“CWDs”), may also take place in step 620. Additionally, information regarding the assets may be gathered during the audit stage such as nameplate information, information regarding related documentation, and other identifying information useful in the creation of structured content. Documents and other information to associate with particular information assets may also be indicated during step 620. A user in a first country, for example, might not wish to associate information pertaining to safety regulations in a second country with a particular asset when that asset is not used in the second country. When the audit is complete, a structured list of verified assets is generated, step 630.

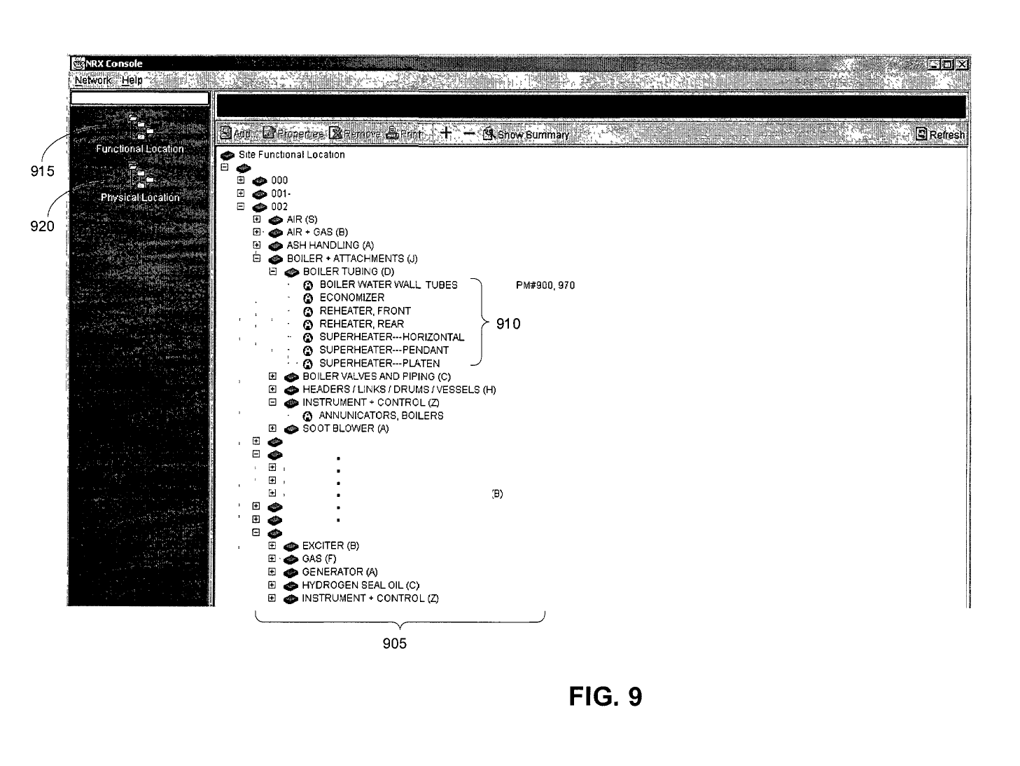

Referring to FIG. 9, a sample screenshot depicts the display of a PDA, computerized tablet, or other computing device used to perform an audit matching items on an expected asset list with those items actually in use or present at a plant. In some embodiments, this screen is accessible from a content viewer client. A tree hierarchy is used to represent a structured list of expected assets 905. Expected assets 910 can be displayed via icons 915 and 920 according to a functional location hierarchy or a physical location hierarchy respectively. In some embodiments, this screen is also displayed in the administration module or the asset auditor module of a content tools client.

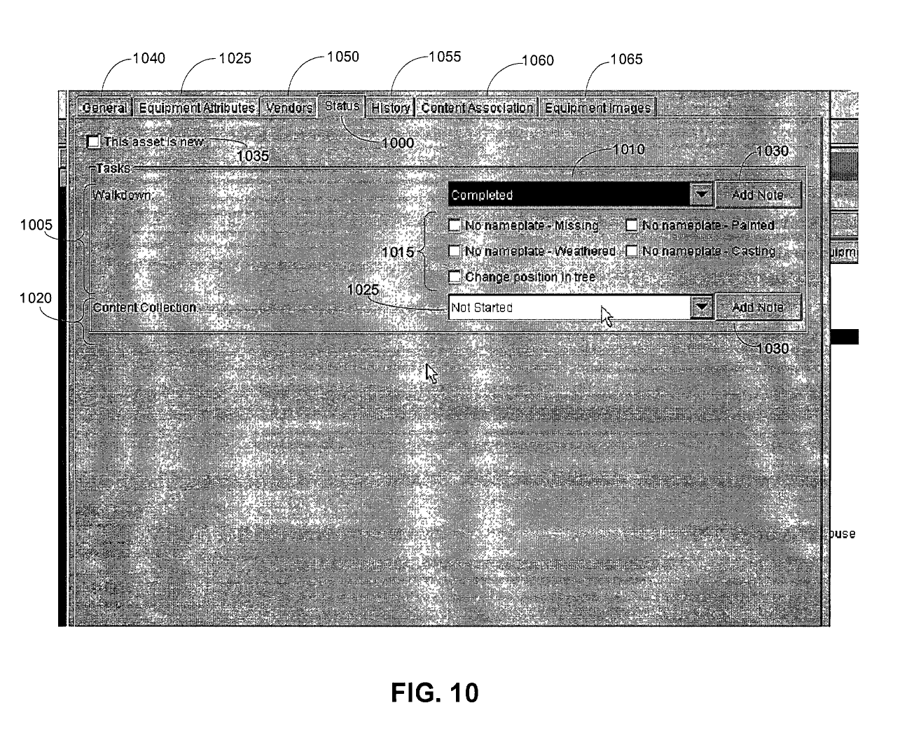

FIG. 10 depicts yet another sample screenshot of the display of a PDA, computerized tablet, or other computing device used to perform an audit matching items on an expected asset list with those items actually in use or present at a plant. In some embodiments, this screen is accessible from a content viewer client. An asset status tab 1000 associates additional information with expected assets subject to audit and collection as further described herein. In some embodiments, this information is aggregated in a content management server.

Asset status tab 1000 contains an audit component section 1005 which allows a user to associate information regarding the audit status of an asset with the asset via a dropdown menu 1010 or other suitable graphical user interface (“GUI”) device as known in the art. Audit component section 1005 presents checkboxes to associate additional information with an audited asset via checkboxes 1015 or other suitable selection means. Additional information might include information discovered during the physical audit such as whether an asset has a nameplate or other distinguishing characteristics of the asset.

Asset status tab 1000 contains a content collection component section 1020 which allows a user to associate information regarding the collection status of an information item associated with an asset via a dropdown menu 1025. Both content collection component section 1020 and audit component section 1005 enable a user to associate additional information with assets and information items associated with assets via add note buttons 1030. For example, workers could enter notes of maintenance information regarding the upkeep of a particular asset using note buttons 1030.

Additional tabs to enter, access, or manipulate general asset information 1040, equipment attributes 1045, vendor information 1050, audit history 1055, association with other content 1060, and equipment images 1065 are also displayed and accessible from this screen. In some embodiments, this screen is also displayed in the administration module or the asset auditor module of a content tools client.

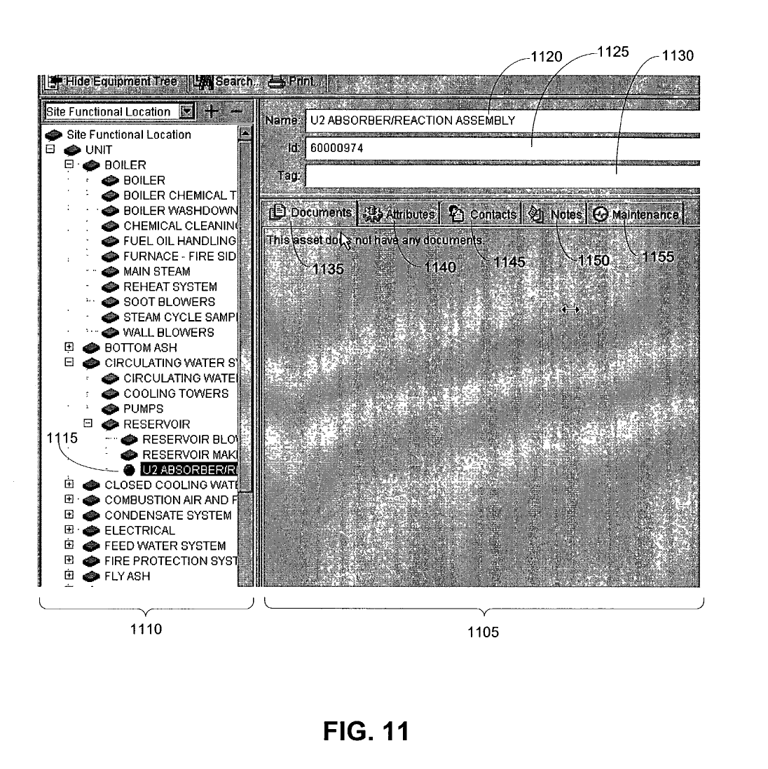

FIG. 11 presents yet another sample screenshot of the display of a PDA, computerized tablet, or other computing device used to perform an audit matching items on an expected asset list with those items actually in use or present at a plant. In some embodiments, this screen is accessible from a content viewer client. In some embodiments, some or all of the auditing described herein will take place using traditional methods such as obtaining a hard copy printout of the list of assets to be verified and indicating results by hand, tape recordings, labeling, and other record keeping techniques known in the art.

Here, an asset information section 1105 and the standardized structured data model 1110 is displayed. Information such as the name 1120, unique identifier 1125, and tag 1130 of asset 1115 contained in data model 1110 may be modified in asset information section 1105. Also displayed in asset information section 1105 are a documents tab 1135 which displays a dialog enabling a user to associate documents with a asset 1115, an attributes tab 1140 which displays a dialog enabling a user to specify additional attributes for asset 1115, a contacts tab 1145 which displays a dialog enabling a user to specify an individual or organization to contact with respect to information about or supplying asset 1115, a notes tab 1150 which displays a dialog enabling a user to enter additional notes regarding asset 1115 to share with other users, and a maintenance tab 1155 which displays a dialog enabling a user to associate with asset 1115 planning lists of materials used for repeated maintenance jobs to share with other users.

Returning to FIG. 6, in some embodiments, the structured list of verified assets is structured in the form of one or more tree hierarchies as known in the art. Typically, a viewer client will have several alternative views of the assets based on various factors such as, for example, physical layout, function, role, etc.

The list of verified assets is compared to a structured data model representing information expected to be associated with each asset contained in the verified list of assets, step 635. Since the assets are mapped against a standardized structured data model of assets, each individual machine asset or node of the standardized tree is already known thus permitting the incorporation of corresponding information and documentation expected to be associated with assets of the structured data model. For example, if the standardized structured data model is for a coal plant, then the assets contained in the model will represent parts, machinery, fixtures, and assets used in a coal plant. These parts and equipment have known information that is useful to associate with them such as parts manuals, operating manuals, maintenance diagrams, safety and environmental manuals, bills of materials, P&IDs, CWDs, and other information used for these parts and equipment during operation of the coal plant. For example, information obtained from the P&ID or the CWD associated with a first asset could be used to shut down related systems and other assets when maintenance must be performed on the first asset. The machine assets of the verified list of assets are compared with and mapped against the structured data model's associated information to generate a list of expected documents and other information content items associated with the assets of the verified list of assets, step 635.

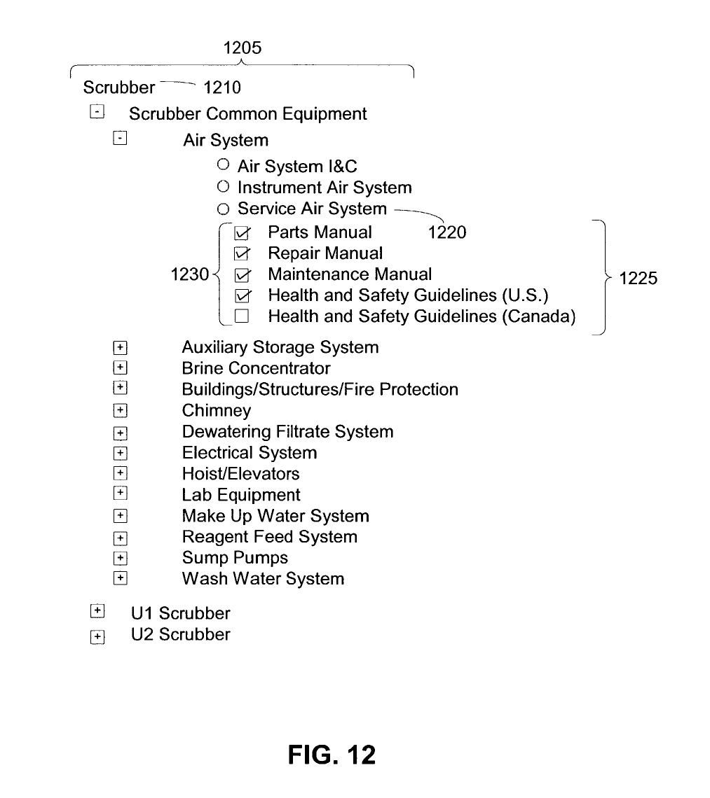

Referring to FIG. 12, a sample screenshot depicts a document data model 1205 representing information expected to be associated with assets contained in the verified list of assets. Document data model 1205 is organized as a tree hierarchy with systems 1210, subsystems 1215, and individual asset nodes 1220 that correspond to and can be mapped against a verified list of assets. Each individual asset node 1220 has information content items 1225 which may be selected to associate with the asset node 1220. Checkboxes 1230 indicate which information content items 1225 to associate with individual asset node 1220, however, radio buttons and other selection means known in the art could also be employed as indicators.

In many cases, some of the items on the verified information content list are stored electronically in existing document management systems or other accessible memory structures. Items are retrieved from the existing document management systems or accessible memory structures and stored in a content database or other accessible memory structure for processing as structured content as further described herein, step 645. Often, documents stored in existing documents management systems are stored in many different formats which makes them more difficult to access. One advantage to processing such items already stored electronically as structured content is to verify that all documentation is stored in a common format including documents already stored electronically. Returning to FIG. 6, a calculation is then performed by comparing the verified and expected lists of information content, step 650, to determine whether any items contained in the verified information content list have still not been retrieved. If all items have been retrieved, the routine ends, step 655. Otherwise, a list is generated containing those items from the verified information content list which have not been retrieved, step 660. Input is accepted in step 665 regarding whether additional retrieval of items shall be performed. A user, for example, might in step 670 manually scan, manually enter, obtain from an OEM content database, or otherwise input hard or soft copy content items contained in the verified information content list. If no additional retrieval of items shall be performed, then the routine ends, step 655. Otherwise, input of additional retrieved items is accepted, step 670, and control passes again to step 645 for further processing.

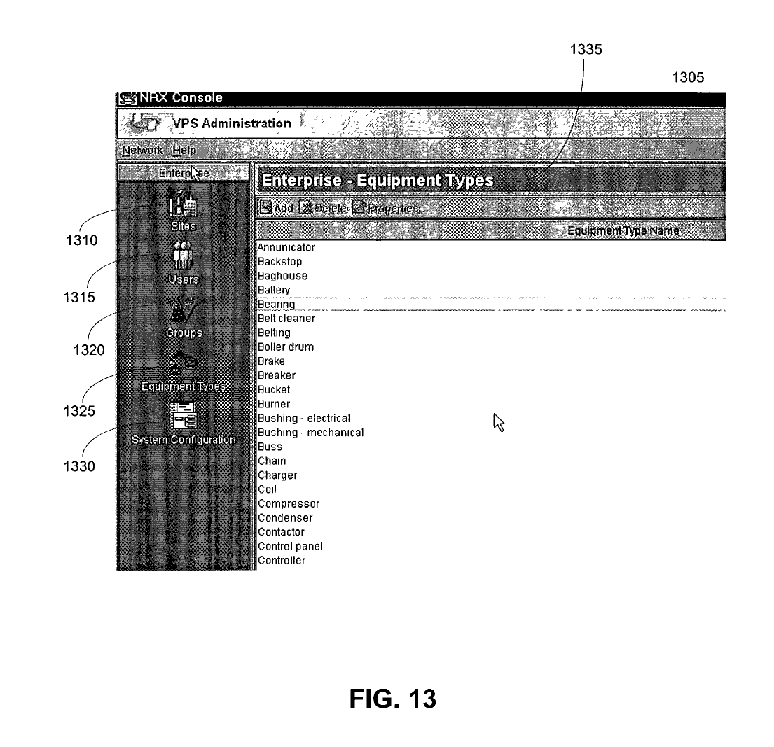

Turning to FIG. 13, a sample screenshot from an administration module of a content tools client is shown depicting a high-level management control center 1305. In some embodiments, this screen is accessible from a PDA, computerized tablet, or other computing device used to perform an audit. In other embodiments, this screen is accessible from a content viewer client. The left side of the screen displays a variety of selectable icons used to initiate management tasks regarding sites 1310, users 1315, groups 1320, equipment types 1325, and system configuration 1330. On the right side of the screen, a results window 1335 displays information associated with the selected management task.

The manage sites task indicated by selecting icon 1310 manipulates information and performs management tasks associated with sites including ERP synchronization, asset management, vendor management, structured data management, inventory fulfillment, reporting functions, tracking site history, and other tasks further described herein. The manage users task indicated by selecting icon 1315 and the manage groups task indicated by selecting icon 1320 manage tasks associated with management and authentication services to track and control access to structured content and other aspects of the system. The manage equipment types task indicated by selecting icon 1325 manages tasks for associating equipment document or attribute requirements with different equipment types. The manage system configuration task indicated by selecting icon 1330 manages tasks such as network configuration, storage management, and other system configuration tasks known in the art.

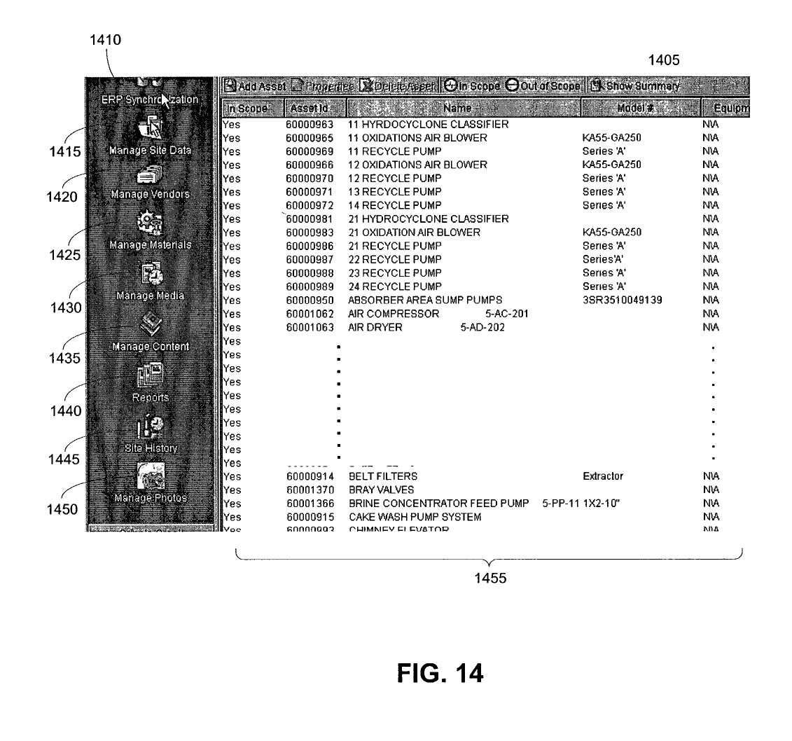

Turning to FIG. 14, a sample screenshot depicts a site management control center 1405 accessible from the manage sites icon 1310 of a content tools client's administration module, a PDA, computerized tablet, a content viewer client, or other computing device used to perform an audit. The left side of the screen displays a variety of selectable icons used to initiate management tasks including ERP synchronization 1410, manage site data 1415, manage vendors 1420, manage materials 1425, manage media 1430, manage content 1435, reporting 1440, site history 1445, and manage photos 1450. On the right side of the screen, a results window 1455 displays information associated with the selected management task.

ERP synchronization 1410 imports data from existing ERP systems into a content management server. Manage site data 1415 maps the imported ERP data onto a standard content template or data model for the particular type of facility from which the data is obtained. Manage site data 1415 also manipulates information content pertaining to individual assets mapped to the data model. Manage vendors 1420 manipulates information pertaining to vendors to the facility and allows this information to be associated with assets mapped to the data model. Manage materials 1425 correlates individual parts comprising each asset mapped to the data model with the existing inventory system's SKU numbers. Manage media 1430 manages tasks associated with content identification and tracking. Manage content 1435 manages tasks associated with structured content. Reporting 1440 manages reporting functions associated with the structured content. Site history 1445 maintains an audit trail associated with input and modification of structured data, as well as previous versions or archived history of the structured content. Manage photos 1450 manages tasks associated with any photographs or illustrations of assets including storage management of photos taken of assets during an audit or collection process.

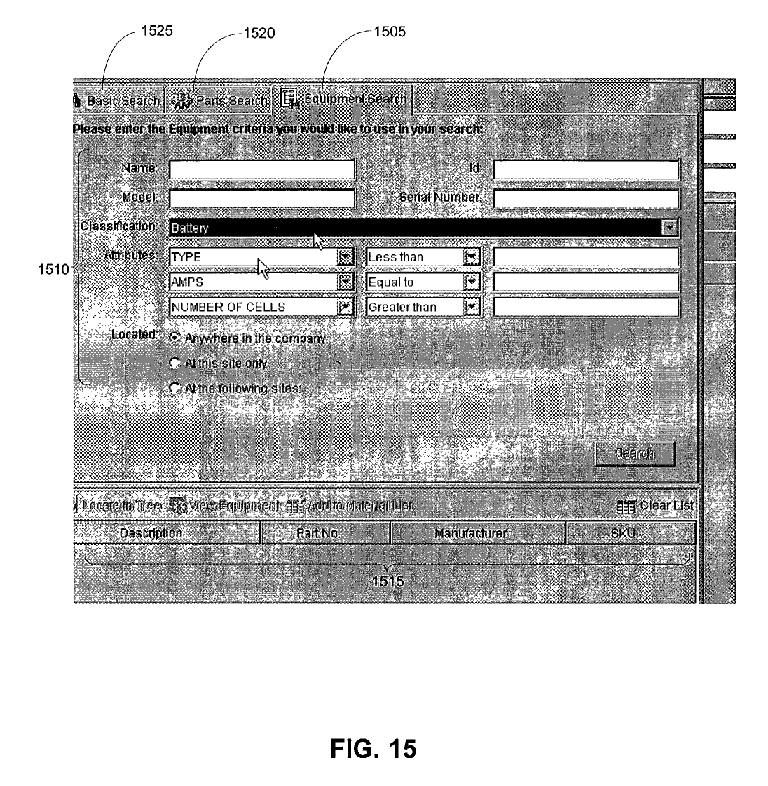

Turning to FIG. 15, another sample screenshot from an administration module of a content tools client is shown depicting a dialog accessible through selection of an equipment search tab 1505. The equipment search tab 1505 offers an optional method of searching for equipment assets and other types of structured content by issuing queries to the content database and having search results returned by database query functions such as query functions present in Microsoft SQL server. Search fields 1510 are presented as means to specify criteria upon which to search. Criteria include name, identifier, model, serial number, asset classification type, attributes, location, and other criteria suitable to distinguish among items of structured content. A results window 1515 is presented below displaying structured content items matching the criteria specified for the search. Searching is not limited to equipment. Tabs are also displayed containing appropriate criteria selection means for searching other items including parts 1520, as well as conducting a basic search 1525 of all accessible information.

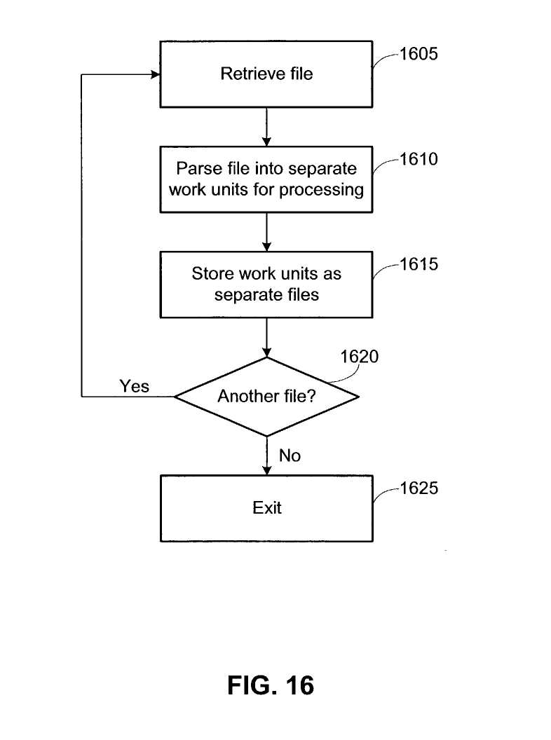

Turning to FIG. 16, a flow diagram depicts one embodiment of a method in accordance with the invention to pass workflow through a content assessor module. The content assessor module retrieves a file, step 1605. Files are stored in a database such as a content database or other accessible memory structure. The content assessor module parses the file elements as directed by a user into separate work units, step 1610. For example, a file may contain many different types of elements such as graphical elements and textual elements which require different processing to convert into structured content. These parsed elements are stored as separate files for further processing, step 1615. Parsed element files may be stored in the original content database or they may be stored in another database or accessible memory structure. The content assessor module accepts input from a user indicating whether an additional file requiring assessment should be retrieved from the content database, step 1620, in which case control returns to step 1605. Otherwise, the routine ends, step 1625.

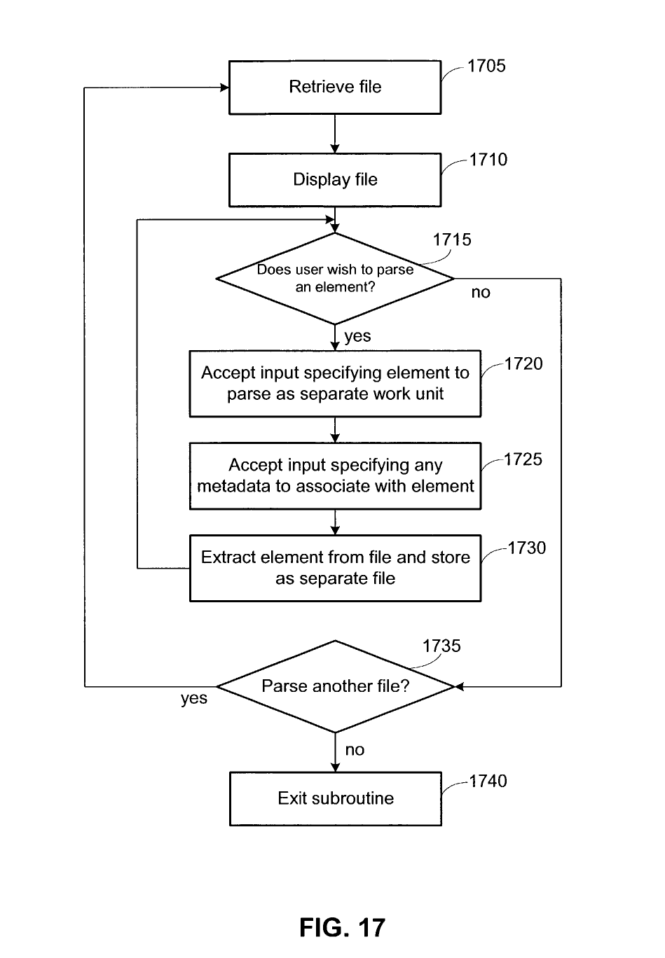

FIG. 17 depicts a more detailed flow diagram of a method to pass workflow through a content assessor module. The content assessor module retrieves a file, step 1705. Files are stored in a database such as a content database or other accessible memory structure and many contain raw information content that has not been converted into structured content. For example, repair manual pages may be image scanned and stored as files in a content database.

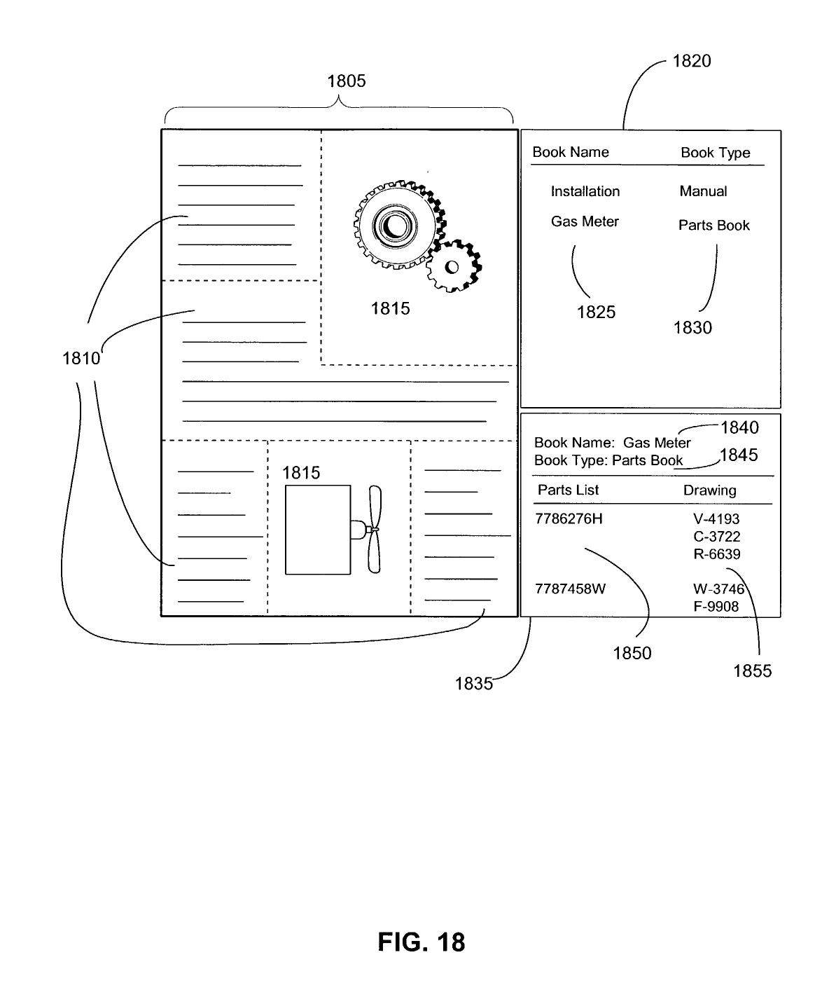

Referring to FIG. 18, an exemplary screenshot from a content assessor is displayed. A first window 1805 displays the file or manual page currently being processed. The individual elements which comprise the manual page are shown including textual elements 1810 and graphical elements 1815. Some files may also contain multimedia elements such as sound and video recordings. Image files cannot be manipulated or mapped to structured content models unless the individual elements which comprise the manual pages are extracted and processed as atomic units of information corresponding to a structured content model. A second window 1820 displays the books 1825 according to type 1830 that are currently being created by the user from individual elements. A third window 1835 identifies the particular book 1840 and book type 1845 with which a user is associating an individual element of content. Users indicate individual elements with crop tools or other selection tools known in the art. Once cropped, individual elements can be associated with books by “dragging and dropping” elements onto their corresponding books. For example, the third window 1835 shows two parts books 1850 and the individual drawing elements 1855 that are associated with them. To associate additional elements, a user would crop an element from the first window 1805, drag the cropped element to the third window 1835, and drop the element next to the appropriate parts book 1850 thus completing the association.

Returning to FIG. 17, the assessor module displays the retrieved file, step 1710 and accepts user input indicating whether there are any elements of the file which should be parsed as separate work units for further processing, step 1715. If there are no elements to parse or the file is appropriate to keep intact for processing, then control passes to step 1735 to determine whether another file should be retrieved and parsed.

Otherwise, if elements remain, the content assessor module accepts input from a user regarding which file elements to parse, step 1720. For example, a user might use a crop tool or other selection means known in the art to indicate a content element that should be parsed as a separate work unit. Alternatively, the assessor module may automatically determine a file element to parse according to parsing logic accessible to the assessor module.

The assessor module accepts input from a user indicating processing parameters to facilitate conversion processing and converts these parameters into metadata associated with a parsed element, step 1725. Metadata associated with a parsed element will vary in content according to what further processing will be performed on the parsed element. For example, a user might categorize the element as a drawing and indicate a number of tasks to be performed such as cleaning the element, “hot pointing” the element, associating it with a parts list, and including it in a particular parts book. A user may indicate other tasks regarding whether an element should be compressed to reduce file size, converted into a PDF or other file type suitable for inclusion in a book of multiple file pages, bookmarked to facilitate navigation within a larger book of parsed elements, classified as a BOM for association with a parts list or other group of items, “hot pointed” as a drawing to facilitate navigation among parsed elements, classified as a TOC to facilitate navigation among parsed elements, hyperlinked to facilitate navigation among parsed elements, or other actions to facilitate conversion into structured content. Alternatively, the assessor module may automatically determine metadata to associate with a parsed element according to metadata association logic available to the assessor module.

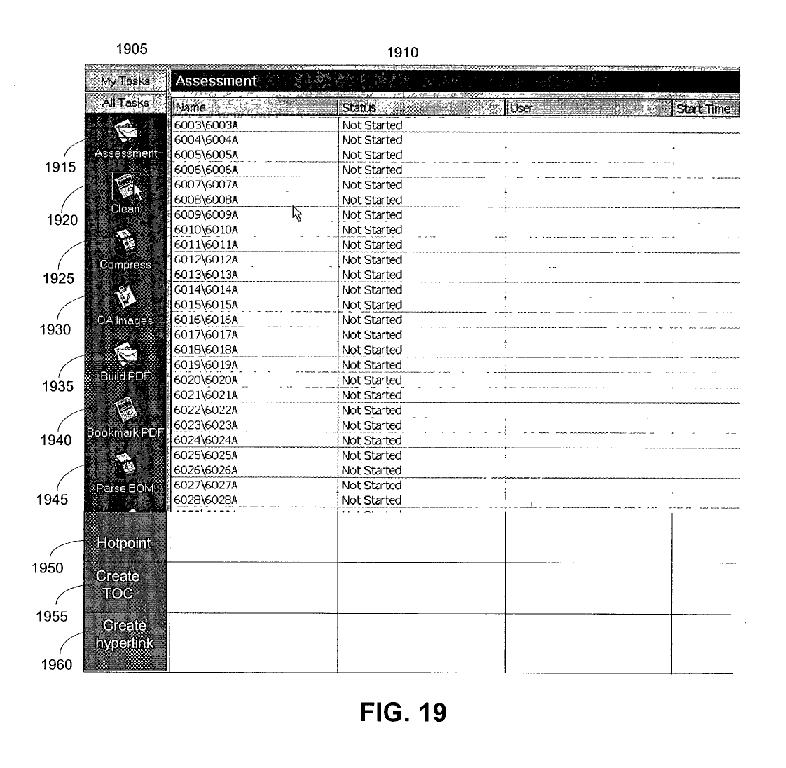

Referring to FIG. 19, a sample screenshot from a content assessor module is displayed. A first window 1905 presents icons for associating metadata with and manipulating parsed elements. A second window 1910 displays results and other information used to associate metadata with and manipulate parsed elements. For example, second window 1910 displays a list of items such as files or parsed elements to be processed by the assessor module and the processing status of each item. First window 1905 presents exemplary icons for assessment 1915, cleaning 1920, compression 1925, quality assurance 1930, PDF creation 1935, bookmark creation 1940, BOM parsing 1945, “hot pointing” 1950, TOC creation 1955, and hyperlink creation 1960.

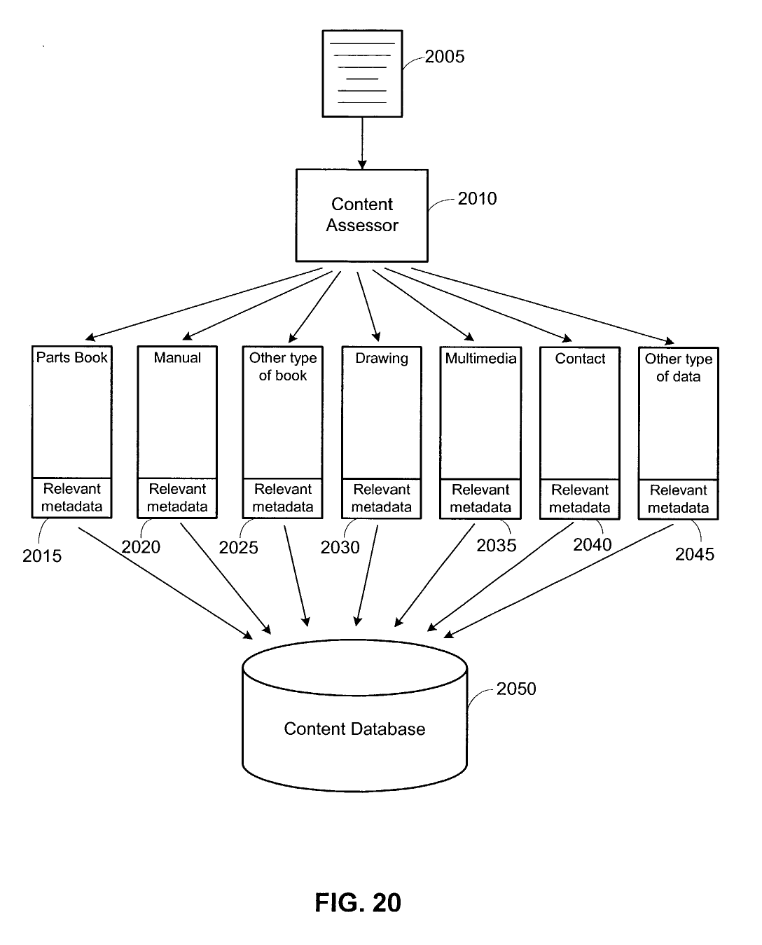

Referring to FIG. 20, a flow-schematic diagram of another exemplary use of metadata in a content assessor module is presented. Metadata associated with a parsed element may also indicate the parsed element's association with a collection of other parsed elements that together comprise a related “book” of content pertaining to a particular asset. Information content 2005 is passed to the content assessor 2010 where individual elements are parsed and stored in a content database 2050 or other accessible memory structure. The content assessor 2010, according to the composition and content of the individual parsed elements may associate these parsed elements together to form content books such as a parts book 2015, a manual 2020, or other type of book 2025 of parsed elements useful to be associated together as structured content. The content assessor may also associate related books with each other to create a library or other collection of related books. The content assessor may also associate metadata with individual parsed elements such as a drawing or graphical element 2030, a multimedia element 2035, a contact element 2040, or other type 2045 of parsed element useful to be converted into structured content.

In some embodiments, a parts book 2015 contains a plurality of parsed elements such as drawings and parts lists, and associated metadata indicating identification of relevant columns of parts lists to process, associations between parts lists and drawings, areas of drawings to be “hot pointed”, identification of individual parsed elements, and other information useful in converting the collection of parsed elements into structured content to create a parts book. A manual 2020 contains parsed elements such as drawings and parts lists, and associated metadata indicating the type of manual such as an operating manual, a health and safety manual, or an installation manual, a TOC to be created from parsed elements, bookmarks to facilitate navigation of the manual, the output file type such as a PDF, and other information useful in converting the collection of parsed elements into structured content to create a manual. Other types of books 2025 include a plurality of parsed elements and associated metadata to be converted into structured content.

Content assessor 2010 associates metadata with drawing or graphical element 2030 to indicate the name of graphical element 2030, the description of graphical element 2030, an output file type for graphical element 2030 such as AutoCad, SVG, PNG, and other output file types known in the art, hotspots linking graphical element 2030 to other documents or other parsed elements, and other information useful in converting graphical element 2030 into structured content. Content assessor 2010 associates metadata with multimedia element 2035 to indicate the name and description of multimedia element 2035, the output file type for multimedia element 2035 such as AVI, MPEG, RM, and other output file types known in the art, the delivery method for multimedia element 2035 such as streaming, downloading, or other delivery methods known in the art, and other information useful in converting multimedia element 2035 into structured content. Content assessor 2010 associates metadata with contact element 2040 indicating the type of contact for contact element 2040 such as whether the contact is a distributor or a manufacturer, the fields of contact element 2040 to be processed such as address fields, phone numbers, facility locations, specializations, and other information useful in converting contact element 2040 into structured content. Content assessor 2010 associates metadata with other parsed elements 2045 indicating information useful in converting the parsed element into structured content.

Returning to FIG. 17, the content assessor module extracts the parsed element from the retrieved file and stores the parsed element with any associated metadata as a separate file in a content database or other accessible memory structure, step 1730. Alternatively, the content assessor module may not store the parsed element as a separate file and instead only store information identifying the element to parse from the original file and/or any related processing instructions. Control returns to step 1715 to accept user input regarding whether additional elements remain to be parsed. If there are no additional elements to parse, then control passes to step 1735 to determine whether additional files should be retrieved and parsed. If additional files should be retrieved and parsed, control returns to step 1705 to retrieve another file or else the routine exits, step 1740.

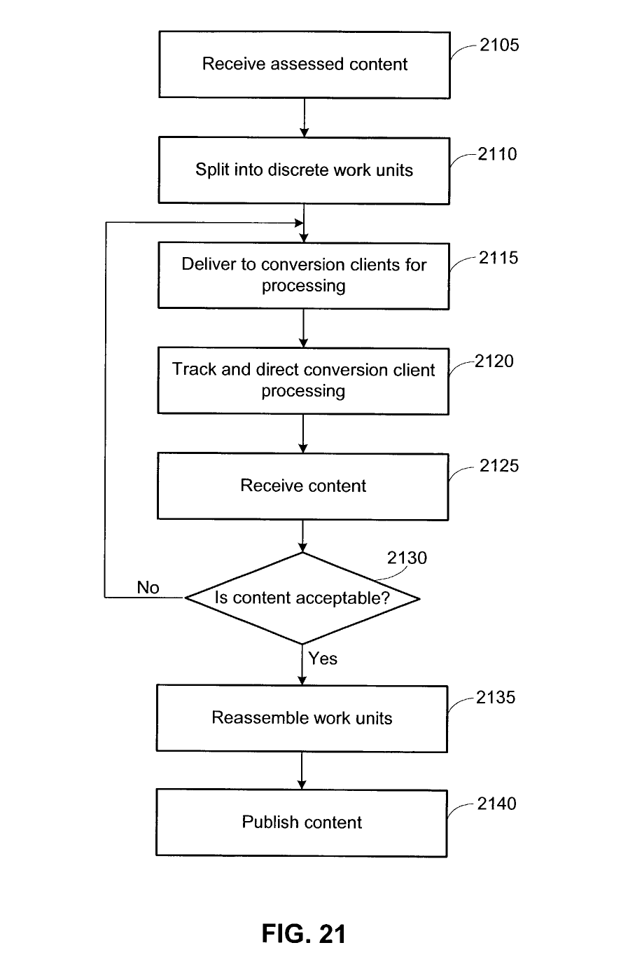

FIG. 21 depicts a flow diagram of one embodiment of a method according to the invention of processing assessed content in a content conversion network. Assessed content is received by the content conversion network, step 2105. Assessed content may be unsolicited and sent to the content conversion network by a content management server requesting processing from the content conversion network. Alternatively, the content conversion network may solicit and retrieve assessed content directly from a content management server.

Assessed content is split into discrete blocks or work units according to metadata associated with the assessed content, step 2110. Work units are delivered to conversion clients communicatively coupled to the content conversion network for conversion processing, step 2115. Conversion processing by the conversion clients is tracked and directed by the content conversion network, step 2120. The content conversion network monitors the performance of conversion clients to achieve efficient content processing. Performance factors evaluated include time to process content, cost to process content, resource sensitivity, and other factors useful to track in evaluating conversion processing. The content conversion network uses this information to effectively “load-balance” and “skill-balance” conversion processing among multiple content conversion clients. For example, when a first content conversion client has a large amount of content to process or is otherwise processing content slowly or at unacceptable quality levels for some reason, the content conversion network may stop sending additional content to the first content conversion client and start sending additional content to a second content conversion client that is processing content more efficiently. Processed work units are received back from the conversion clients, step 2125. If the conversion processing performed on the work units by the conversion clients is acceptable, then the work units are reassembled and packaged as structured content, step 2135, in books or as otherwise specified by metadata associated with the work units, and published to a content database or other accessible memory structure, step 2140. If the conversion processing performed on the work units by the conversion processing is not acceptable, then those work units that have been unacceptably processed are returned to the conversion clients or alternatively to other conversion clients for further processing and control reverts to step 2115.

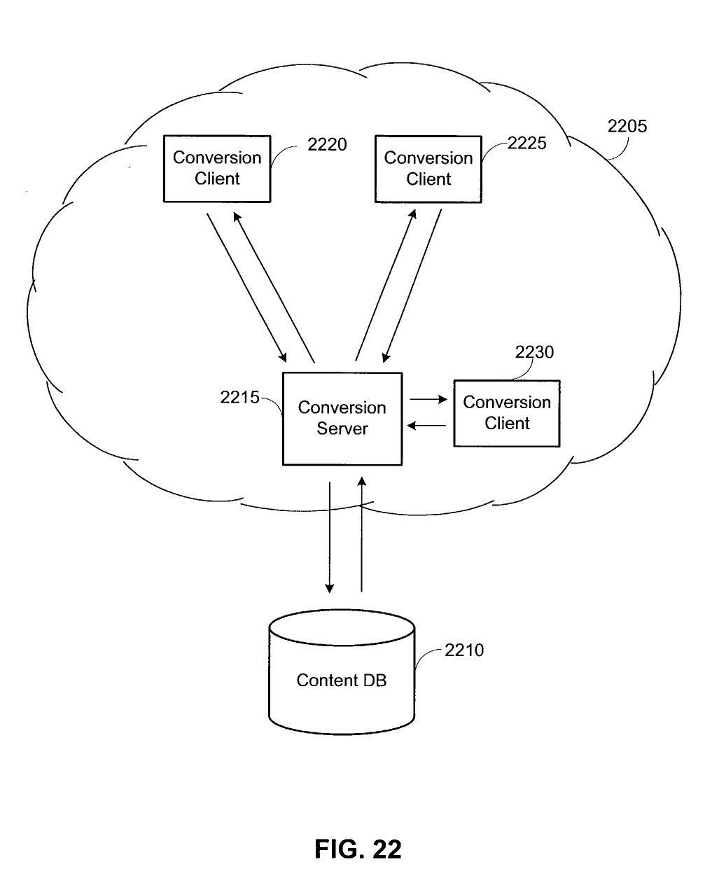

FIG. 22 is a block diagram depicting a high-level system architecture of a content conversion network 2205 according to one embodiment of the present invention. A content database 2210 storing assessed content to be processed is communicatively coupled to a content conversion server 2215. The content database 2210 may reside on the same physical network as the content conversion server 2215, or they may reside on different networks with communication taking place via the Internet or other means. The content conversion server monitors and directs conversion processing in content conversion network 2205. Conversion clients 2220, 2225, and 2230 are communicatively coupled to content conversion server 2215. Conversion clients 2220, 2225, and 2230 may reside on the same physical network as content conversion server 2215 or they may reside on different networks with communication taking place via the Internet or other means. Conversion clients 2220, 2225, 2230 communicate with content conversion server 2215 using TCP/IP or another suitable communication protocol known in the art and retrieve files from content conversion server 2215 for conversion processing using FTP or another suitable file transfer method known in the art. Conversion clients 2220, 2225, and 2230 perform the actual conversion processing of assessed content retrieved from content database 2210 as directed by content conversion server 2215. Content conversion clients 2220, 2225, and 2230 process assessed content according to individual processing capabilities and may have differing associations with content conversion network 2205. For example, conversion clients 2220 and 2225 may be third-party clients outside the content conversion network contracted for specialized processing of assessed content and conversion client 2230 may be a workstation or other computing device within content conversion network 2205 performing other processing as directed by an employee of a company operating content conversion network 2205. In some embodiments, content conversion clients 2220, 2225, and 2230 use a variety of methods to connect to the content conversion network 2205. Content conversion clients 2220, 2225, and 2230 may use a thin client software module merely to obtain content and then process content using other tools unrelated to the current system. Alternatively, content conversion clients 2220, 2225, and 2230 may use a content tools client or, via a web browser, use content tools provided by an application service provider such as the Assignee of this patent application to process content.

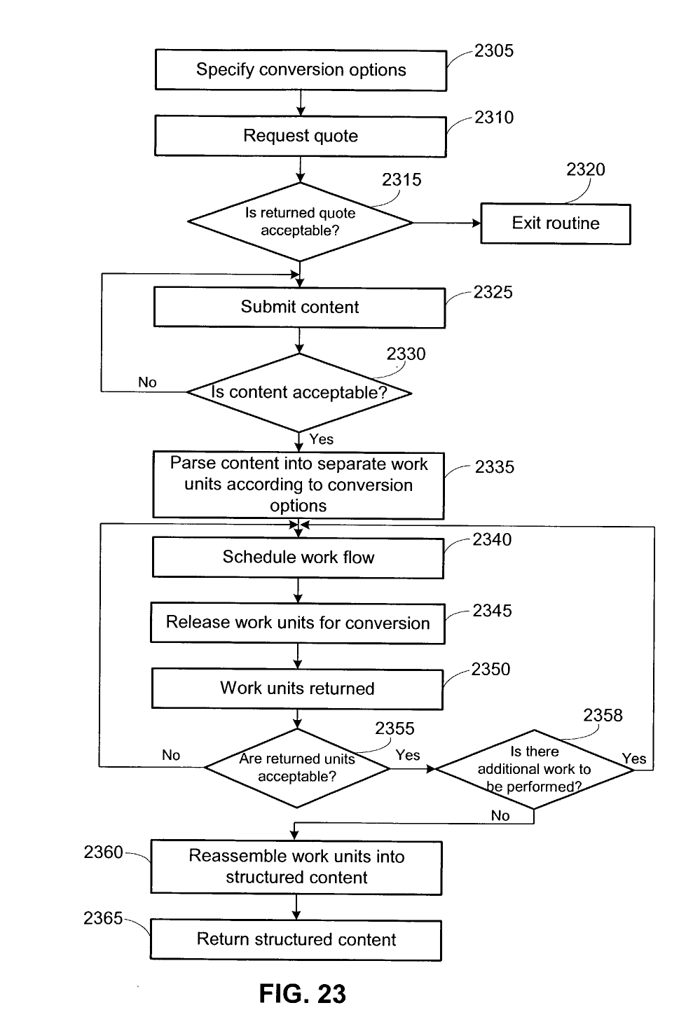

FIG. 23 presents a more detailed flow diagram of a method to process content in a content conversion network according to one embodiment of the invention. A content management server specifies conversion options for content, step 2305, and requests a price quote from a content conversion network for converting the content according to the specified options, step 2310. The price quote is automatically generated by the content conversion network. Content conversion clients have pre-submitted price lists to perform particular tasks associated with conversion processing. The content conversion network evaluates the conversion options specified by the content management server, determines the quantity of material to be converted, determines how much such conversion processing will cost according to the pre-submitted price lists of the content conversion clients, and returns a quote to the content management server for approval.

Content may be pre-assessed or content may need to be assessed by the content conversion network if the price quote is acceptable. For example, a company may use a content tools client to pre-assess their content prior to submitting it to the content conversion network. Alternatively, a company may choose to submit raw unassessed content and have both assessment and conversion processing performed by the network. Conversion options may be submitted manually, for example as direct user input, or conversion options may be automatically extracted by the content management server or the content conversion network from metadata associated with assessed content to be converted. In some embodiments, the request for a price quote may be passed to a content conversion client for a response.

The returned quote is evaluated, step 2315. If the quote is not acceptable, then the routine ends and exits the conversion process, step 2320. Otherwise, if the returned quote is accepted, the content management server submits the content for conversion processing, step 2325. The content conversion network evaluates the submitted assessed content to determine whether the content is suitable for conversion processing or if the content requires modification before it can be processed and converted into structured content, step 2330. Business rules and logic governing workflow utilize the metadata associated with an element for conversion processing. The content conversion server verifies that all metadata required to process the content is available. For example, a content management server may have neglected to associate metadata with the submitted assessed content indicating how the content should be processed and converted into structured content. Such content cannot be processed and would need to have the metadata associated with it before conversion processing could occur unless the content conversion network were to also perform assessment on the submitted content in addition to conversion processing.

If the submitted content is suitable, then the content is assessed if necessary and parsed into separate work units according to the business rules and logic utilizing the conversion options specified in the metadata, step 2335. Conversion options associated with a work unit will vary in content according to what further processing will be performed on the parsed element. For example, conversion options associated with a work unit may indicate the work unit's association with a collection of other work unit's that together comprise a “book” of content. Conversion options may also indicate further processing tasks regarding whether an element should be cleaned to remove graphical artifacts resultant from a scanning process, compressed to reduce file size, converted into a PDF or other file type suitable for inclusion in a book of multiple file pages, bookmarked to facilitate navigation within a larger book of parsed elements, classified as a BOM for association with a parts list or other group of items, “hot pointed” as a drawing to facilitate navigation among parsed elements, classified as a TOC to facilitate navigation among parsed elements, hyperlinked to facilitate navigation among parsed elements, or other actions to facilitate conversion into structured content. Conversion options are specified in metadata associated with submitted content. Alternatively, conversion options are specified via direct user input during the submission or conversion process.

Conversion processing workflow is scheduled, step 2340. Pricing may vary according to processing time requirements of the submitting party. Some work units may require multiple conversion processing tasks performed on them in a specific order. For example, a drawing should be cleaned before being “hot pointed” and a table of contents must be entered as text before being hyperlinked. Accordingly, workflow is scheduled to process work units in an appropriate order as efficiently as possible. Workflow is also scheduled to effectively “load-balance” and “skill balance” conversion processing among multiple content conversion clients and verify that work units are processed as efficiently as possible at acceptable quality levels by conversion clients as further described herein.

Work units are released for conversion according to associated conversion options and workflow schedule, step 2345. Work units may be submitted directly to specific content conversion clients, or alternatively, work units may be placed in a content conversion queue or other data structure from which conversion clients can retrieve work units to convert into structured content.

Conversion clients return processed work units, step 2350, and work units are evaluated to determine whether the processing performed is acceptable, step 2355. In some embodiments, conversion clients perform their own quality checks to determine whether processing performed is acceptable prior to returning the processed work units, step 2350. If the processing performed is not acceptable, then control returns to step 2340, and unacceptable work units are rescheduled for additional conversion processing. If the processing performed is acceptable, then system determines whether additional conversion processing tasks must be performed on any of the work units, step 2358. For example, certain tasks must be performed before other tasks can be accomplished such as cleaning an image before “hot pointing” it or creating a TOC. If additional conversion processing tasks must be performed on any of the work units, then control returns to step 2340, and those work units are rescheduled for additional conversion processing. Otherwise, the work units are reassembled and packaged as structured content as specified by metadata or other information associated with the work units, step 2360. Structured content is then returned to the content management server which submitted the original assessed content, step 2365.

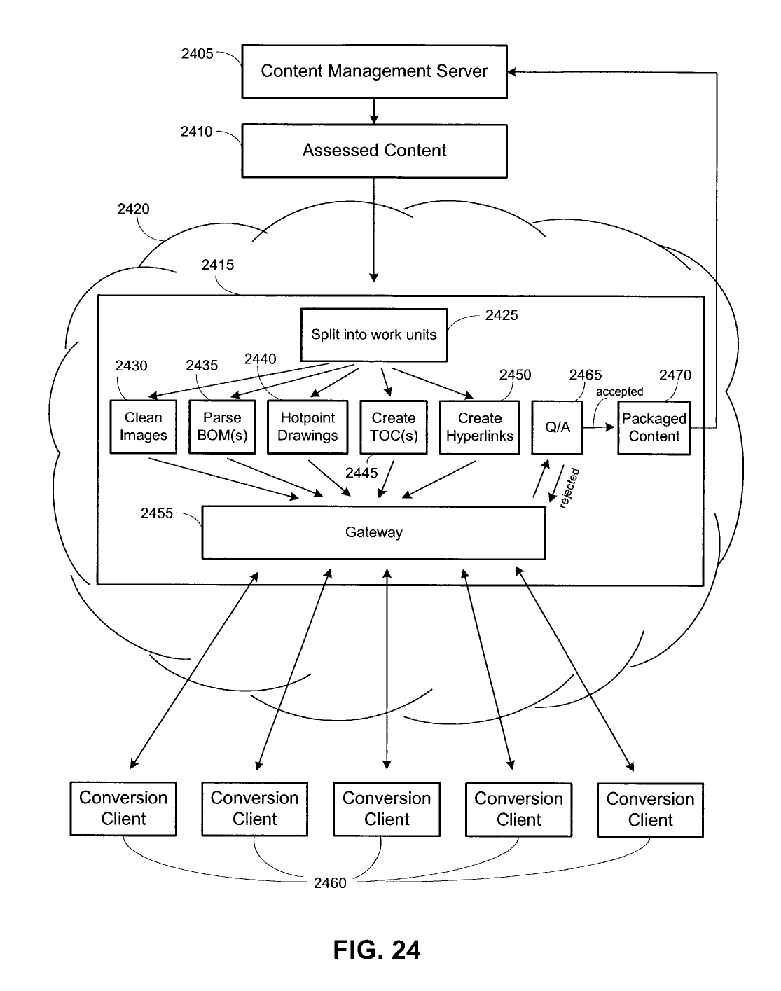

FIG. 24 depicts an exemplary flow-schematic diagram of assessed content being processed in a content conversion network. A content management server 2405 submits assessed content 2410 to a content conversion server 2415 that is a part of content conversion network 2420. Alternatively, content may be submitted by companies desiring to have their content processed in the content conversion network without using a content management server or a content tools client. As further described herein, submitted assessed content 2410 has associated metadata or other information indicating processing tasks to be performed and associations between individual content elements. Content conversion server 2415 evaluates submitted assessed content 2410 and organizes it into separate work units for conversion into structured content. As shown, exemplary processing to be performed on work units include cleaning images 2430, parsing BOMs 2435, “hot pointing” drawings 2440, creating TOCs 2445, and creating hyperlinks 2450. Other tasks may be performed on work units as required. Content conversion server 2415 submits parsed work units 2430, 2435, 2440, 2445, and 2450 to a content conversion gateway 2455 for workflow scheduling and release to content conversion clients 2460. Content conversion clients 2460 process parsed work units, optionally perform their own quality checks, and return processed work units to conversion gateway 2455 for quality assurance approval 2465. Rejected work units are returned to conversion clients 2460 for further processing. Accepted work units are either resubmitted to additional conversion clients 2460 for additional scheduled processing or, if no additional conversion processing is required, packaged as structured content 2470 to be returned to content management server 2405.

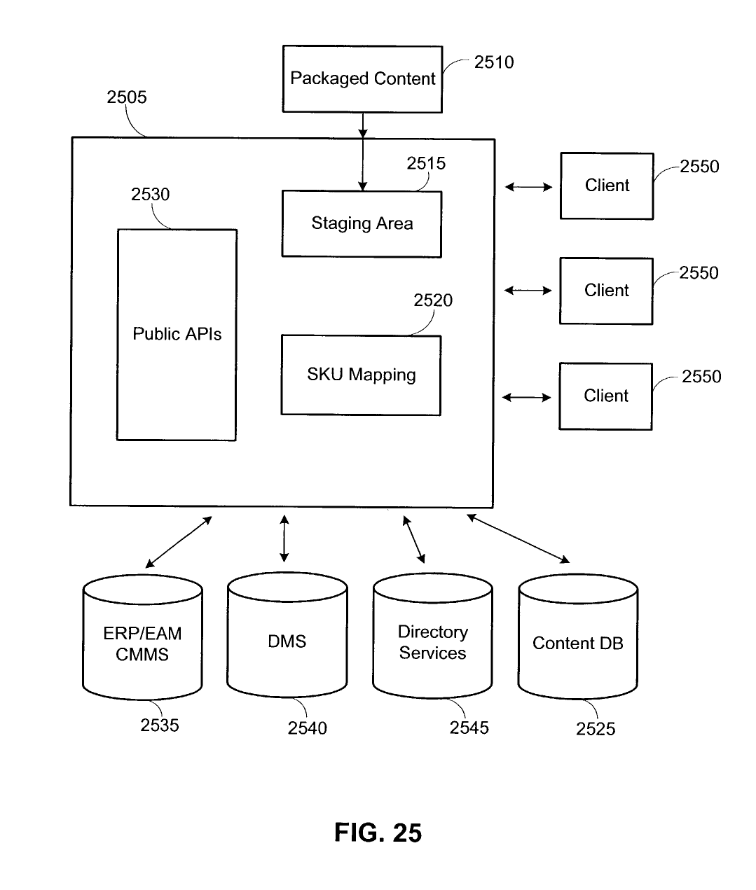

FIG. 25 presents a detailed block diagram of the systems contained in a content management server 2505 according to one embodiment of the invention. A content management server includes one or more programs or modules which, in addition to other functions as further described herein, performs tasks associated with managing structured content. Content management server 2505 includes a staging area 2515, a SKU mapping module 2520, a content database 2525, a public Application Program Interface (“API”) module 2530, an ERP/EAM/CMMS database 2535, a DMS database 2540, and a directory services database 2545.

Packaged structured content 2510 is received by content management server 2505 and stored in a staging area 2515 memory structure. Content management server 2505 stores packaged structured content 2510 in staging area 2515 while content management server 2505 manipulates or otherwise manages packaged structured content 2510. For example, content management server 2505 may store packaged structured content 2510 in staging area 2515 for processing by SKU mapping module 2520.

SKU mapping module 2520 provides logic used by a content tools client SKU Mapping Module to match structured content customer SKUs with OEM part numbers from parts lists and other documents that were collected and converted into structured content. Individual parts processed as structured content must be mapped to and associated with the assets of the structured content model as further described herein.

Content management server 2505 exposes public APIs 2530 to facilitate manipulation of structured content. For example, content tools clients link to public APIs 2530 to adjust asset properties. As another example, content tools developers or other parties could use the public APIs 2530 to extend the system or to manipulate content in other ways. Existing enterprise management systems 2535 such as ERP systems, CMMS, and EAM systems are communicatively coupled to content management server 2505. These systems provide additional capabilities with respect to producing and using structured content generated. For example, integration with the existing ERP system permits checking inventory availability, work order integration, and associating SKU information with assets contained in the structured content.

Existing Document Management Systems 2540 are also communicatively coupled to content management server 2505. DMS 2540 contains computer-readable document files pertaining to machine assets and other matters associated with the enterprise. Information contained in DMS 2540 is retrieved to generate structured information content.

A directory services system 2545 is also communicatively coupled to content management server 2505 providing user management and authentication services to track and control access to the structured content stored in content database 2525. Content viewer clients 2550 request content management server 2505 deliver structured content stored in content database 2525. Content management server 2505 utilizes directory services system 2545 to authenticate user requests and permission levels. Optionally, as previously described, certain content viewer clients 2550 have access to different kinds of structured content and other systems associated with the present invention based on job role, location, or other distinguishing factors as indicated by directory services system 2545.

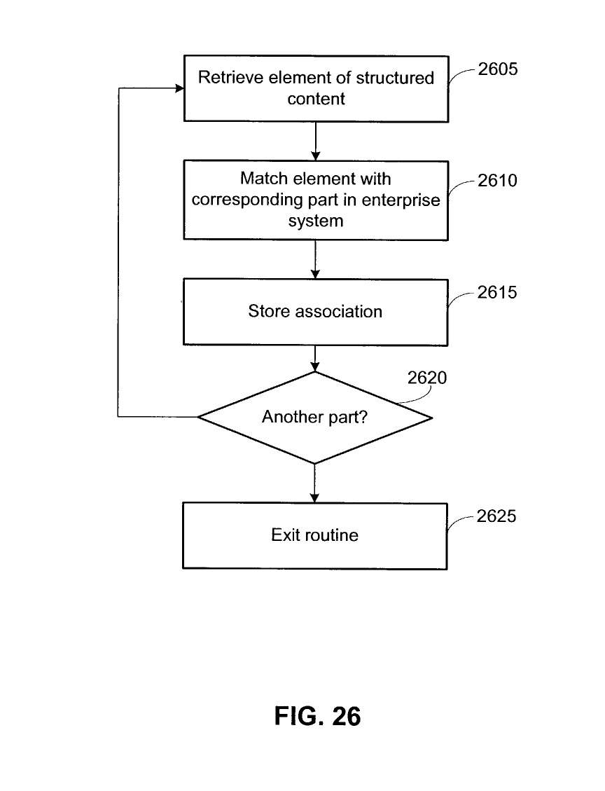

FIG. 26 depicts a flow diagram of a method according to one embodiment of the invention to match company SKU numbers with structured content. An element of structured content representing an individual part is retrieved, step 2605. The element of structured content is compared to and matched with a corresponding part in an existing ERP system or other system, step 2615. The association between the element of structured content and SKU number of the corresponding part in the existing ERP system is stored as metadata associated with the element of structured content, step 2615. Input is accepted to indicate whether another structured content element should be matched to a SKU number, step 2620. If another structured content element should be matched to a SKU number, then control returns to step 2605, or else the routine exits, step 2625.

Items processed and output from the conversion process may still need to be matched to existing ERP items. In some embodiments, when ERP items are mapped in a structured data model, the mapping and association between the ERP system and the structured data model initially occurs at the machine and subsystem level only and does not extend to include the individual component parts of each machine and subsystem. Machines and subsystems comprising many individual parts are thus the most granular elements of the structured content model used during the audit process. This may be done for reasons of efficiency since an ERP system may contain several hundred thousand parts and only a few thousand machines and related subsystems, thus it is more efficient to map these machines and subsystems between the ERP system and a structured data model. Additionally, ERP systems with so many parts often contain legacy information about parts that are no longer in use and other incorrect information.

Later, during content assessment and conversion processing into structured content, additional individual parts are isolated as content elements and associations are made between individual parts and machines and subsystems. These associations, however, are only made between individual parts and machines and subsystems in the structured data model since content assessment and conversion occurs only on items mapped to the structured data model. At this stage, no association is made to match elements of structured content representing individual parts back to individual parts in the ERP system. Further, identifying information about a part processed as an element of structured content and associated with an asset of the structured data model often does not match identifying information for the same part in the ERP system.

For example, when an audit is performed of assets in a plant, documents containing information associated with these assets are collected and parsed into structured content as further described herein. An asset such as a water pump might have a parts manual with a BOM of the individual parts that comprise the water pump. When the BOM is parsed during content assessment, the parts are actually entered as structured data during content conversion and associated with the water pump asset in the structured content model. The parts, however, only have identifying information obtained from the physical audit process such as OEM nameplate information and OEM identifying information indicated in the parts manual BOM. This OEM identifying information may not match information contained in a company's existing ERP system since companies often use internally created SKUs for identifying parts in their ERP systems. The identifying information obtained from the physical audit process and other OEM information obtained from related documents during content conversion, however, can be used to match and associate individual parts processed as structured content with parts information stored in a company's ERP systems.

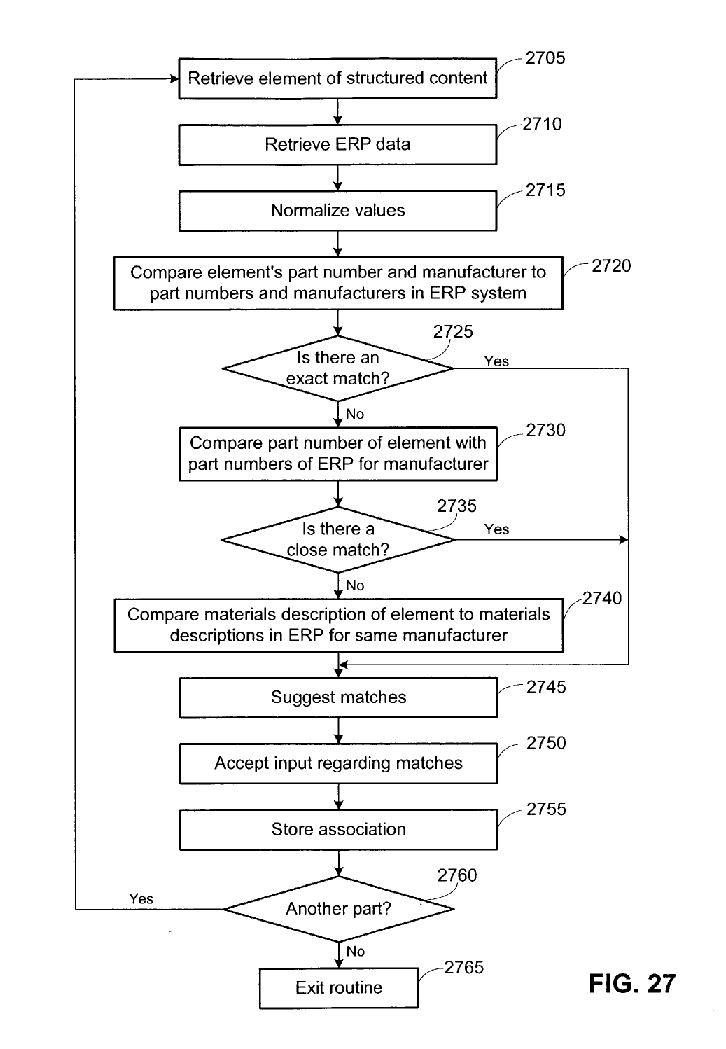

FIG. 27 depicts a more detailed flow diagram of a method according to an embodiment of the invention to match company SKU numbers with structured content. An element of structured content representing an individual part is retrieved, step 2705. ERP data for all parts stored in the ERP system is also retrieved, step 2710. All values are then normalized according to predetermined and configurable rules, step 2715. For example, identifying information associated with the element and all parts from the ERP system will have spaces, non-alphabetic, and numeric characters removed. A thesaurus or other reference may also be used to standardize abbreviations such as having occurrences of “assy” changed to “assembly”. Normalization avoids problems associated with parts numbers being entered into the ERP system and parts books in different formats which may create difficulties in matching company SKUs with structured content. Because normalization parameters are configurable by the user, customers can change rules to normalize their data to best suit the SKU system in use at their facility.

The part number and manufacturer identity of the element of structured content is compared to all part numbers and manufacturers stored in the ERP system, step 2720. If there is an exact match, step 2725, then the match is presented to the user for confirmation, step 2745. Alternatively, the system may automatically confirm the match. Alternatively, a user may wish to customize the criteria used to evaluate matches and weight different variables accordingly based on their particular requirements.

If there is not an exact match of the part number and manufacturer identity, the part number of the element of structured content is compared using a fuzzy string comparison with all ERP part numbers associated with the same manufacturer as the manufacturer associated with the element of structured content, step 2730. If the string comparison returns any high probability matches, step 2735, then those ERP parts with high probability matches are presented to the user for confirmation, step 2745. Alternatively, the system may automatically confirm the match. If there is not a high probability part number match, the part description of the element of structured content is compared using a fuzzy string comparison with all ERP part descriptions associated with the same manufacturer as the manufacturer associated with the element of structured content, step 2740. Those ERP parts with the highest probability matches are then presented to the user for confirmation, step 2745. Alternatively, the system may automatically confirm the match.

The user input or the system determination of the correct match between the element of structured content and the corresponding part in the ERP system is accepted, step 2750, and the association between them stored as metadata associated with the element of structured content, step 2755. The system determines whether another part should be processed, step 2760, and control either returns to step 2705 to process another part, or the SKU mapping routine ends, step 2765.

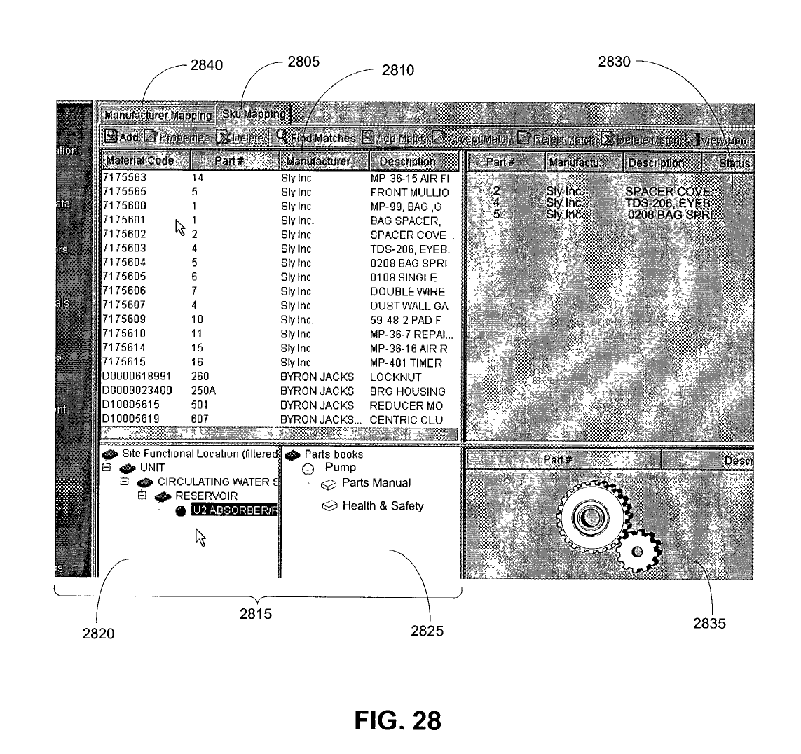

FIG. 28 presents a sample screenshot of a user interface of a SKU mapping tab 2805 for matching company SKUs with structured content. A first window 2810 displays information about parts and other items stored in the company's ERP system. A second window 2815 displays structured data which must be associated with ERP data contained in the first window 2810. In this exemplary screenshot, the second window is subdivided into two windows with a left sub-window 2820 displaying a tree hierarchy view of a structured data model containing machine assets, and a right sub-window 2825 displaying a tree hierarchy view of a structured data model containing parts books. A third window 2830 displays suggested matches of parts from the parts books window 2525 corresponding to parts selected from the ERP system in the first window 2810. A fourth window 2835 displays additional information to assist in evaluating whether any suggested matches presented in third window 2830 are correct. For example, fourth window 2835 may display digital photographs taken during an audit of parts stored in a company's warehouse which can be compared with diagrams from a parts manual or digital photographs taken of an asset during the audit process described above. The user interface also displays a manufacturer mapping tab 2840 to match manufacturers stored in a company's ERP system with manufacturer information associated with items of structured content using logic similar to the logic the system employs to match company SKUs with OEM identification information associated with items of structured content.

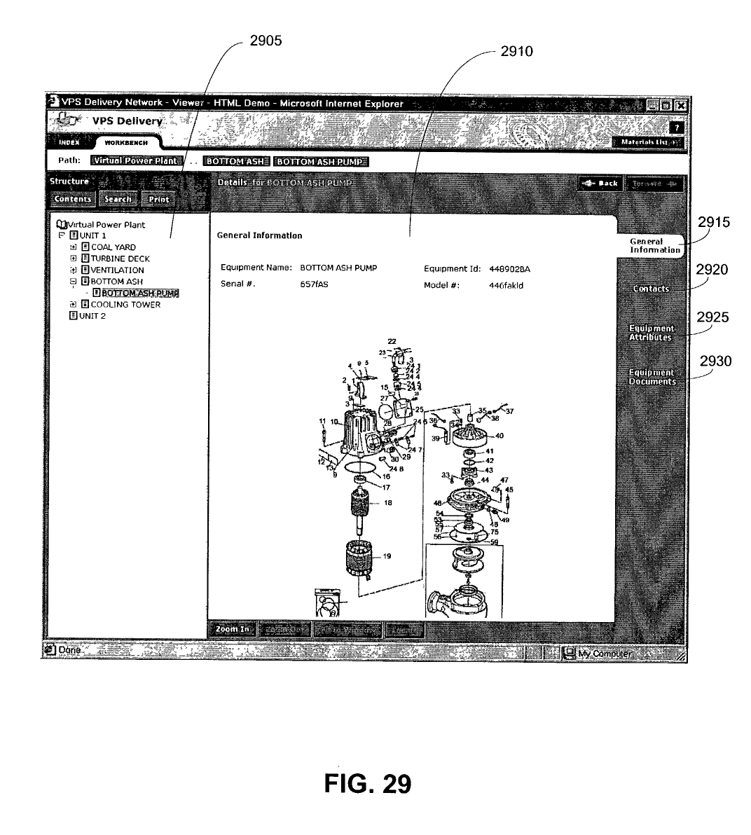

FIG. 29 presents a sample screenshot of a content viewer client to display structured content. The content viewer client displays a first window 2905 which displays plant assets as structured content according to a tree hierarchy view or other view as determined according to the requirements of the content viewer client. A second window 2910 displays information associated with structured content assets selected from the asset tree of first window 2905. Selectable icons used to display additional information associated with the selected structured content asset are presented including general information 2915, contacts 2920, equipment attributes 2925, and equipment documents 2930.

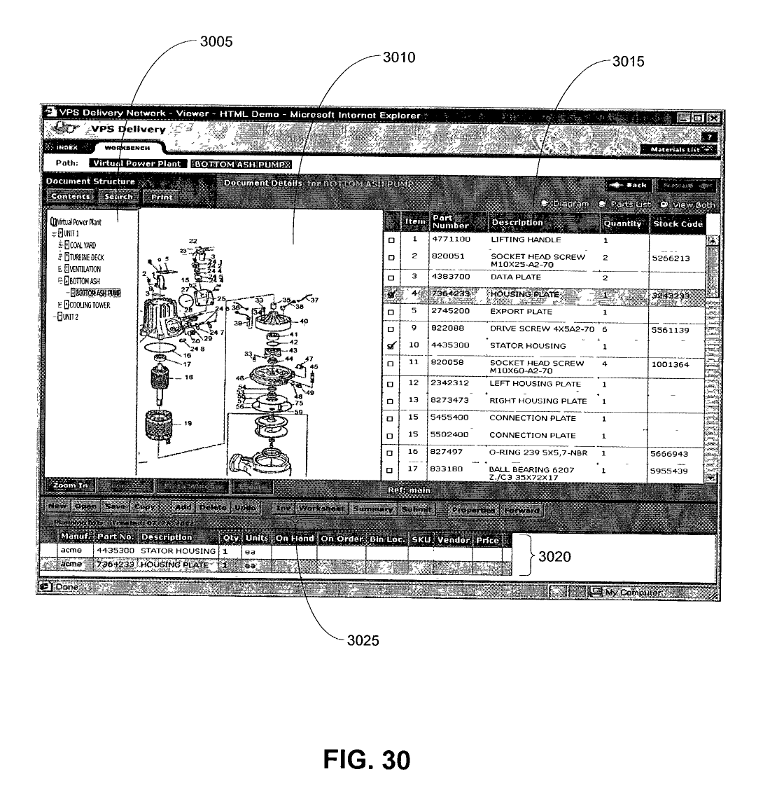

FIG. 30 presents another sample screenshot of a content viewer client to display structured content. The content viewer client displays a first window 3005 which displays plant assets as structured content according to a tree hierarchy view. A second window 3010 displays information associated with structured content assets selected from the asset tree of first window 3005. A third window 3015 displays additional information associated with structured content assets selected from the asset tree of the first window 3015. For example, here second window 3010 displays a parts diagram and third window 3015 displays a parts list for the structured content asset selected in first window 3005. A fourth window 3020 displays a materials list containing items selected from the parts list of third window 3020. Selection means 3025 are presented to manipulate information contained in the materials list including means to create a new list, open an existing list, save the current list, copy the list, add items, delete items, undo changes, link to inventory systems such as ERP systems, create a worksheet, print a summary, submit the materials list for further processing, display the properties of the list, and forward the list to another party.

The plant assets displayed in the first window 3005 as structured content according to a tree hierarchy view or other view are presented according to the same structured content model and tree hierarchy originally established during the audit process described above. The suite as a whole and the individual tools and methods described herein thus work together and provide a system to facilitate the operation of facilities. For example, the data model and the audit tool and process provide the ability to produce a verified list of documents associated with assets and equipment of the facility. In conjunction with the assessor module, the documents are reduced to discrete elements providing highly relevant data pertaining to facility operations without extraneous information. The content conversion network converts these elements into structured content creating meaningful associations between elements. The content server delivers the structured content to content viewer clients providing users with new means of accessing important information used in operating the facility. By way of another example, the assessor and the conversion network alone also provide significant advantages in the operation of facilities. The assessor categorizes document elements and feeds them to the content network to efficiently process structured content in a cost-effective manner. The audit tool and the conversion network provide yet another example. Even without the assessor, conducting an audit and feeding the audit results to the conversion network produces at minimum highly relevant verified content useful in the operation of a facility.

In some embodiments, the overall process or components of the overall process described herein are repeatedly used to maintain data and structure content in a plant or facility. The verified data list is maintained and kept current as part of an ongoing and continuing process. Additionally, the verified data list, the components and tools of the process described herein, and combinations thereof are also used to constantly maintain accurate and up to date enterprise data in systems such as ERP systems, document management systems, EAM systems, and other systems.

Systems and modules described herein may comprise software, firmware, hardware, or any combination(s) of software, firmware, and/or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or via other means suitable for the purposes described herein. Data structures described herein may comprise computer files, variables, programming arrays, programming structures, and/or any electronic information storage schemes or methods, or any combinations thereof, suitable for the purposes described herein. User interface elements described herein may comprise elements from graphical user interfaces, command line interfaces, and other interfaces suitable for the purposes described herein. Screenshots presented and described herein can be displayed differently as known in the art to input, access, change, manipulate, modify, alter, and work with information. Different structured data or a different portion of the structured data may be presented differently to different users. For example, a hierarchical list of assets or structured content could be displayed differently as a graphic or other form suitable for the purposes described herein. As another example, a portion of a hierarchical list of assets may be displayed to a first user and a different portion of a hierarchical list of assets may be displayed to a second user.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A method for managing a set of documentation relating to assets used in a plant, the method comprising:
generating a list of documents at least in part through access to stored data in an asset management system used by the plant, the documents relating to the plant assets;
aggregating electronic versions of all or some of the selected documents in the list;
converting the aggregated electronic documents into structured documents having a number of categorized document elements; and
coordinating processing of the categorized document elements in accordance with predetermined criteria.

2. The method of claim 1, wherein generating the list of documents comprises retrieving stored data from the plant's asset management system identifying assets used by the plant and applying a hierarchical data model to the stored data to identify documents expected to be located in the plant.

3. The method of claim 2, comprising conducting an audit of assets used in the plant to verify the stored data from the asset management system, thereby generating a list of documents related to plant assets verified to be present in the plant.

4. The method of claim 1, wherein aggregating electronic versions comprises receiving electronic versions from distributors of the electronic documents.

5. The method of claim 1, wherein aggregating electronic versions comprises providing all or part of the list of documents to a collector, the collector using the list of documents to locate hard copies of the documents at the plant, and scanning the hard copies to create the electronic versions of the documents.

6. The method of claim 1, wherein converting the aggregated electronic documents comprises dividing each electronic document into two or more document elements and associating each document element with a processing category.

7. The method of claim 6, wherein dividing and associating comprise using a software tool to divide and associate the document elements.

8. The method of claim 7, comprising allowing selection through the software tool of one or more processing parameters for processing of the categorized document elements, and storing the selected processing parameters with the categorized document elements.

9. The method of claim 1, wherein coordinating processing of the categorized document elements comprises coordinating a network of entities each capable of performing one or more specific processing tasks.

10. The method of claim 1, comprising using a software viewing tool to display the processed document elements.

11. The method of claim 1, comprising integrating data from the processed document elements with the asset management system.

12. The method of claim 11, wherein one or more processed document elements identify equipment parts used in plant assets, and wherein integrating data from the processed document elements with the plant's asset management system comprises matching equipment parts identified in the one or more processed document elements with parts identified by the plant's asset management system.

13. A method for supporting management a set of documentation relating to assets used in a plant, the method comprising:
providing a first software module for accessing stored data in an asset management system used by the plant and generating a list of documents to be collected;
providing a second software module for facilitating aggregation of electronic versions of all or some of the documents in the list; and
providing a third software module for facilitating selection of document elements within each of the aggregated electronic documents and association of the selected document elements with a plurality of categories to thereby generate a set of categorized document elements configured to be converted into structured documents.

14. The method of claim 13, comprising providing an hierarchical asset data model with the first software tool, the first software tool applying the asset data model to the stored data accessed from the plant's asset management system to select the list of documents as those expected to be relevant to or located at the plant.

15. The method of claim 13, comprising providing the plant access to a network configured to coordinate the processing the categorized document elements through a plurality of entities.

16. The method of claim 15, wherein one or more processed document elements identify equipment parts used in plant assets, and comprising providing a fourth software module for integrating data from the processed document elements with the plant's asset management system and for matching equipment parts identified in the one or more processed document elements with parts identified by the plant's asset management system.

17. A method for managing a set of electronic documents relating to assets used in a plant, the method comprising:
using a software tool to convert the electronic documents into structured documents having a number of document elements categorized according to one of a plurality of processing techniques to be applied on the document elements;
transmitting the categorized document elements to a conversion network; and
the conversion network coordinating processing of the categorized document elements in accordance with the processing techniques.

18. The method of claim 17, comprising receiving processed document elements from the conversion network.

19. The method of claim 18, comprising using a software tool to view the processed document elements.

20. The method of claim 18, comprising integrating data from the processed document elements with an asset management system operated by the plant.

21. The method of claim 20, comprising matching assets identified in the processed document elements with assets identified in the asset management system.

22. The method of claim 17, comprising using the software tool to select processing parameters for use in processing each of the categorized document elements and transmitting the selected processing parameters with the respective categorized document elements.

23. The method of claim 17, comprising generating a list of the documents at least in part by verifying the presence of first assets in the plant as a condition to inclusion in the list of first documents related to the first assets.

24. The method of claim 23, wherein verifying the presence of first assets comprises conducting an audit of the assets in the plant in comparison to data stored in an asset management system operated by the plant.

25. The method of claim 23, wherein generating the list comprises generating the list having a hierarchical data structure relating assets, subassets, and documents.

26. The method of claim 25, comprising using a software tool to select processed documents at least in part through use of the hierarchical data structure and to view the selected processed document elements.

27. The method of claim 23, comprising collecting the electronic documents contained in the list at least in part by retrieving hard or electronic copies of the electronic documents located on plant premises.

28. A method for managing a set of electronic documents relating to assets used in a plant, the method comprising:
converting the electronic documents into structured documents having a number of categorized document elements;
transmitting the categorized document elements to a network configured to coordinate entities each capable of performing one or more specific processing tasks; and
receiving processed document elements from the network.

29. The method of claim 28, comprising selecting processing parameters for use in processing each of the categorized document elements and transmitting the selected processing parameters with the respective categorized document elements.

30. The method of claim 29, comprising requesting a price quote from the network for processing of the categorized document elements based upon the selected processing parameters, and receiving the price quote from the network.

31. A method for managing a set of documentation relating to assets used in a plant, the method comprising:
generating a list of documents at least in part through access to stored data in an asset management system used by the plant, the documents relating to the plant assets;
aggregating electronic versions of all or some of the selected documents in the list;
converting the aggregated electronic documents into structured documents having a number of categorized document elements; and
transmitting the categorized document elements to a network configured to coordinate entities each capable of performing one or more specific processing tasks.

32. The method of claim 31, wherein generating the list of documents comprises retrieving stored data from the plant's asset management system identifying assets used by the plant and applying a hierarchical data model to the stored data to identify documents expected to be located in the plant.

33. The method of claim 31, wherein aggregating electronic versions comprises receiving electronic versions from distributors of the electronic documents.

34. The method of claim 31, wherein aggregating electronic versions comprises providing all or part of the list of documents to a collector through an electronic hand-held device, the collector using the list of documents to locate hard copies of the documents at the plant, and scanning the hard copies to create the electronic versions of the documents.

35. The method of claim 31, wherein converting the aggregated electronic documents comprises dividing each electronic document into two or more document elements and associating each document element with a processing category.

36. The method of claim 35, wherein dividing and associating comprise using a software tool to divide and associate the document elements.

37. The method of claim 36, comprising allowing selection through the software tool of one or more processing parameters for processing of the categorized document elements, and storing the selected processing parameters with the categorized document elements.

38. The method of claim 37, comprising transmitting the selected processing parameters with the categorized document elements.

39. The method of claim 37, wherein storing the selected processing parameters comprising storing the parameters as metadata associated with each document element.

40. The method of claim 30, comprising receiving processed document elements from the network.

41. The method of claim 40, comprising using a software viewing tool to display the processed document elements.

42. The method of claim 40, comprising integrating data from the processed document elements with the asset management system.

43. The method of claim 42, wherein one or more processed document elements identify equipment parts used in plant assets, and wherein integrating data from the processed document elements with the plant's asset management system comprises matching equipment parts identified in the one or more processed document elements with parts identified by the plant's asset management system.

44. A computer readable medium storing program code representing one or more software modules which, when executed on a computer, cause the computer to perform a method for managing a set of electronic documents relating to assets used in a plant, the method comprising:
converting the electronic documents into structured documents having a number of document elements categorized according to one of a plurality of processing techniques to be applied on the document elements;
transmitting the categorized document elements to a conversion network configured to coordinate processing of the categorized document elements in accordance with the processing techniques; and
receiving the processed document elements from the conversion network.

45. The computer readable medium of claim 44, wherein the method performed by the one or more software modules comprises displaying the processed document elements.

46. The computer readable medium of claim 45, wherein the method performed by the one or more software modules comprises displaying the processed document elements organized in a hierarchical data structure relating assets, subassets, and documents.

47. The computer readable medium of claim 46, wherein the method performed by the one or more software modules comprises generating a list of the documents organized according to the hierarchical data structure.

48. The computer readable medium of claim 47, wherein generating the list of documents as performed by the one or more software modules comprises retrieving data stored in an asset management system operated by the plant and applying a hierarchical template to the retrieved data.

49. The computer readable medium of claim 47, wherein the method performed by the one or more software modules comprises facilitating an audit of plant assets to verify that documents in the list represent assets actually being used by the plant.

50. The computer readable medium of claim 44, wherein the method performed by the one or more software modules comprises facilitating an audit of plant assets to verify that documents represent assets actually being used by the plant.
